(19) United States
(12) Patent Application Publication
(10) Pub. No.: US 2006/0248557 A1
(43) Pub. Date: Nov. 2, 2006

(54) Interface for controlling device groups

(75) Inventors: Korina J. B. Stark, Bellevue, WA (US); Michael Stacie, Kirkland, WA (US); Marcellino Tanumihardja, Seattle, WA (US)

Correspondence Address: SEED INTELLECTUAL PROPERTY LAW GROUP PLLC, 701 FIFTH AVE, SUITE 6300, SEATTLE, WA, 98104-7092, US

(73) Assignee: Vulcan Inc., Seattle, WA (US)

(21) Appl. No.: 11/397,461

(22) Filed: Apr. 3, 2006

Related U.S. Application Data
(60) Provisional application No. 60/667,836, filed on Apr. 1, 2005.
(60) Provisional application No. 60/677,059, filed on May 2, 2005.

(51) Int. Cl. H04N 7/18; G06F 13/00; H04N 5/445

(52) U.S. Cl. 725/37; 725/74; 725/80; 725/81

(57) ABSTRACT

Techniques are described for managing various types of content and devices, such as via a GUI of a Content Management (“CM”) system executing on a computing device. In some situations, the content being managed includes television-related programming content and/or other types of content (e.g., one or more channels of scheduled digital music and/or on-demand digital music, photos and other images, etc.). In some situations, the managing of the content includes identifying groups of devices via the GUI to present or otherwise interact with various types of content, and to controlling one or more of the devices in various ways. The groups of devices may be of various types, such as content presentation devices of a particular type, content presentation devices that are currently located in a particular location, or content presentation devices or other devices that otherwise share one or more indicated attributes of interest.

### CROSS REFERENCE TO RELATED APPLICATIONS

This application claims the benefit under 35 U.S.C. § 119(e) of U.S. Provisional Patent Application 60/667,836, filed Apr. 1, 2005 and entitled “INTERFACE FOR MANIPULATING MULTIMEDIA CONTENT,” and of U.S. Provisional Patent Application 60/677,059, filed May 2, 2005 and entitled “INTERFACE FOR MANIPULATING MULTIMEDIA CONTENT”, each of which is incorporated herein by reference in its entirety.

This application is also related to U.S. patent application Ser. No. ______ (Attorney Docket # 931086.419), filed concurrently and entitled “Interface For Manipulating Multimedia Playlists”; and to U.S. patent application Ser. No. ______ (Attorney Docket # 931086.421), filed concurrently and entitled “Mobile Interface For Manipulating Multimedia Content”; each of which is hereby incorporated by reference in its entirety.

### TECHNICAL FIELD

The following disclosure relates generally to techniques for controlling groups of devices related to content presentation, such as to control groups of devices in a particular location or of a particular type via a graphical user interface of a computing device, including content presentation devices and/or devices for providing content for presentation.

### BACKGROUND

Consumers in today's society are provided with many different types of multimedia content, including various types of audio, television and other video, text, still digital image, Internet Web page, or other multimedia format. Given the large amount of information available to consumers and given the many different multimedia formats available, it is beneficial to assist consumers in identifying, obtaining, and presenting pieces of multimedia content that may be of interest.

In the current world of television, movies, and related media systems, many consumers receive television-related programming content via broadcast over a cable network to a television or similar display, with the content often received via a set-top box (“STB”) from the cable network that controls display of particular television (or “TV”) programs from among a large number of available television channels, while other consumers may similarly receive television-related programming content in other manners (e.g., via satellite transmissions, broadcasts over airwaves, over packet-switched networks such as to stream programs being currently transmitted and/or to download pre-recorded programs, etc.). In addition, enhanced television programming services and capabilities are increasingly being provided to consumers, such as the ability to receive television-related programming content that is delivered “on demand” using Video on Demand (“VOD”) technologies (e.g., based on a fee-based pay-per-view business model) and/or various interactive TV capabilities. Consumers generally subscribe to services offered by a cable network “head-end” or other similar content distribution facility to obtain particular content, which in some situations may include interactive content and Internet content.

In addition, in the current world of music and other audio programs, many consumers receive audio-related programming content via broadcast over the radio, satellite radio, broadcast over a cable network and/or downloaded over packet-switched networks (e.g., the Internet). Images may similarly be available via download over packet-switched networks or via transfer from the devices (e.g., digital cameras, cell phone cameras) that took the images.

Consumers of content are also increasingly using a variety of devices to record and control viewing of content, such as via digital video recorders (“DVRs”) that can record content for later playback and/or can temporarily store recent and current content to allow functionality such as pausing or rewinding live content. A DVR may also be known as a personal video recorder (“PVR”), hard disk recorder (“HDR”), personal video station (“PVS”), or a personal television receiver (“PTR”). DVRs may in some situations be integrated into a set-top box, such as with Digeo's MOXI™ device, while in other situations may be a separate component connected to an STB and/or television. In addition, electronic programming guides (“EPGs”) are often made available to aid consumers in selecting a desired program to currently view and/or to schedule for delayed viewing. Using an EPG and a DVR, a consumer can cause a desired program to be recorded and can then view the program at a more convenient time or location. As another example, the Internet has become a frequently used source of multimedia content. Consumers may obtain music downloads, pictures, audio or video clips, graphical or textual information, or other multimedia content by accessing suitable Web sites and downloading the desired piece(s) of multimedia content from the accessed Web site(s).

Consumers of content are also increasingly using a variety of different content presentation devices with differing capabilities to present content. For example, consumers increasingly have multiple devices capable of presenting audio, although the capabilities may differ (e.g., the relative quality of audio via computer speakers may be low compared to a home stereo). Capabilities for displaying video may similarly vary widely depending on the type of device, including in display size, display resolution, display refresh rate, etc. In addition, consumers also may have multiple grades of the same type of device. For instance, a consumer may have multiple televisions but only one that is capable of 1080i HDTV. Consumers may also have multiple types of inputs to a device with varying associated levels of quality (e.g., for a television, S/Video, HDMI, DVI, component video, and composite video). Portable devices that may be available at least temporarily are also increasingly common. In addition, consumers are also increasingly using many different types of devices in one location at the same time (e.g., using a television to display the television-related content and using a stereo for audio playback of the television-related content).

Consumers also may desire the ability to manage content and related devices from remote locations, such as via the Web. For example, parents may desire to remotely approve access by children to a particular device and/or to one or more particular pieces of content. People also may desire to able to schedule programs from remote locations. Furthermore, as the ability to receive content on a mobile device increases, consumers increasingly also desire access to their content from remote locations such as on their cellphones.

While the proliferation of content and related devices provide various benefits to users, various problems also arise. For example, it is becoming increasingly difficult for consumers to effectively manage the content that is available to them and to effectively manage the related capabilities of the various devices that are available. Thus, it would be beneficial to provide additional capabilities to consumers to allow them to effectively manage content and devices of interest, as well as to provide various other benefits.

### BRIEF DESCRIPTION OF THE DRAWINGS

FIGS. 1A-1B are example embodiments of a graphical user interface (“GUI ”) for a content management system.

FIG. 2 is an example embodiment of a portion of a GUI for use in controlling groups of devices and managing playlists.

FIGS. 3A-3B are block diagrams of example embodiments of a content management system environment.

FIG. 4 is a flow diagram of an example embodiment of a Playlist Manager routine.

FIG. 5 is a flow diagram of an example embodiment of a Device Control Manager routine.

FIGS. 6A-6S provide examples of a GUI and related capabilities that may be used in some embodiments with a cellphone or other device with a limited display screen and/or limited input device capabilities.

FIGS. 7A-7G are examples of various screen contents and flow for an example GUI for use with a cellphone or other device with limited capabilities.

FIG. 8 is a flow diagram of an example embodiment of a Mobile Device Manager routine.

### DETAILED DESCRIPTION

Techniques are described for managing various types of content and devices in various ways, such as via a graphical user interface (“GUI”) of a Content Management (“CM”) system executing on a computing device. In some embodiments, at least some of the content being managed includes television-related programming content, with the CM system receiving EPG metadata information and optionally other types of metadata information for the content (e.g., via interactions with an STB). In such embodiments, the television-related programming content may then be managed via the CM system GUI in a variety of ways, such as to allow a consumer to locate and identify content of potential interest, to schedule recordings of selected content, to manage previously recorded content (e.g., to play or delete the content), to control live television, etc. Similarly, in some embodiments additional types of content may be received (e.g., one or more channels of scheduled digital music and/or on-demand digital music, photos and other images, etc.), and the CM system may similarly receive metadata information (e.g., jacket art, album art, production shots, EPG and other scheduling/availability information, etc.) for and manage such additional types of contents in various ways (e.g., to allow a consumer to locate and identify content of potential interest, to schedule recordings of selected content, to manage previously recorded content, to control live presentation of such content, etc.). In addition, the CM system may further manage various other types of contents and perform various other types of content management functions, as described in greater detail below, and the types of computing devices on which the CM system executes and/or on which the CM system GUI is presented may in some embodiments include personal computers, and cellular telephones and other mobile devices.

In some embodiments, various techniques may be used to manipulate and present groups of one or more pieces (or “items”) of content via a graphical user interface, such as by creating and managing playlists of pieces of television-related and other multimedia content. Such playlists may in at least some embodiments include a mixture of multiple distinct types of content (e.g., by having audio tracks and TV programs in the same playlist), and may be used in a variety of ways. For example, in addition to using playlists to present pieces of content that are already stored (e.g., television programs that have been recorded, song files that have been downloaded, etc.) or otherwise available (e.g., for on-demand download or other retrieval, such as from a subscription service), playlists may in some embodiments be used to control devices in order to acquire pieces of content, such as by auto-tuning a television receiver device (e.g., an STB, DVR, VCR or television) to appropriate channels at appropriate times in order to present a series of appropriate pieces of live content at those times, or to tune a television recorder device (e.g., a DVR or VCR) in a similar manner in order to record a series of pieces of live content for later viewing. Once created, playlists may be further used in various ways, such as to save a playlist for later use (whether for a limited time or on a permanent basis), or to direct a playlist to one or more content presentation devices on which to present the content pieces for the playlist. Playlists may be constructed in various ways in some embodiments, including by receiving indications of currently available pieces of content (e.g., a stored photo or stored music clip or stored episode of a multi-episode television program), of pieces of content that will be available in the future (e.g., a next episode of a multi-episode television program that has not yet been televised or otherwise made available), and of attributes or other criteria to use to identify matching pieces of content (e.g., at a time of use of the playlist). In addition, playlist functionality may be restricted in various ways in some embodiments, such as via parental controls or other usage controls that restrict who may use a playlist, when the playlist be used and/or how the playlist may be used. A variety of additional details regarding the use of playlists are described below.

Techniques are also described for identifying groups of devices to present or otherwise interact with various types of content via a graphical user interface, such as to select one or more content presentation devices of a group on which to present the content. In some embodiments, the CM system manages various types of groups of devices, such as content presentation devices of a particular type, content presentation devices that are currently located in a particular location, content presentation devices having particular types of content presentation capabilities (e.g., the ability to present particular types of content; the ability to present content at a particular level of quality or in a particular manner; the ability to accommodate particular types of DRM (“digital rights management”) technology or other types of content access restrictions, such as encryption; etc.), or content presentation devices that otherwise share one or more indicated attributes of interest. More generally, the CM system may in at least some embodiments further manage devices that provide functionality other than presentation of content. In addition, in some embodiments the CM system may be able to discover and facilitate use of portable devices and other devices that may be available only temporarily, such as due to the device being moved into a location of interest, being turned on or otherwise activated, or finishing one or more other activities that prevented use of the device in a desired manner. In addition, the use of devices may be restricted in various ways in some embodiments, such as via parental controls or other usage controls that restrict who may use a device, when the device may be used and/or how the device may be used. A variety of additional details regarding the controlling and using devices are described below.

In addition, techniques are described for managing various types of content in various ways using a mobile device (e.g., a smartphone or other cellular telephone, PDA or other electronic organizer, etc.), such as via a user interface of a CM system that is displayed on a mobile device. In some embodiments, the CM system user interface for mobile devices may allow a user of a mobile device to have access to some or all of the functionality of the CM system, although limited capabilities of at least some mobile devices (e.g., limited display area, limited bandwidth via a wireless connection, etc.) may cause some types of CM system functionality to be unavailable or to be accessed and used in a manner that is different from that of a similar GUI for use on personal computers. For example, it may be possible to schedule recording remotely, to search for one or pieces of recorded or upcoming content, to select one or more programs to be presented on one or more remote content presentation devices, and to view content on a display of the mobile device (e.g., after the content is transformed to fit on a limited display size or otherwise modified in accordance with transmission and/or display capabilities of the mobile device). Furthermore, in some embodiments such a mobile device may provide additional functionality that may not be available from a corresponding GUI for a personal computer, such as to act as a remote control for one or more content presentation devices and/or content receiver/distributor devices (e.g., via an ability to transmit infrared-based or Bluetooth-based instructions or other signals), and may further be able switch between local networking and remote networking in such a manner as to alter functionality that is available from the mobile device based on such factors (e.g., by turning off the ability to use the mobile device as a remote control when the mobile device is sufficiently distant or remote from the devices to potentially be controlled). A mobile device may also synchronize with the CM system to exchange various types of information, such as metadata about pieces of content for searching, or information specific to activities of a user of the mobile device in order to save and synchronize a state of the user's activities. A variety of additional details regarding the use of a mobile user interface for the CM system are described below.

For illustrative purposes, some embodiments are described below in which specific types of content and groups of content presentation devices are managed in specific ways via specific example embodiments of the CM system GUI. However, it will be appreciated the described techniques can be used in a wide variety of other situations, and that the invention is not limited to the exemplary details provided. More generally, as used herein, pieces or items of “content” generally include television programs, movies and other video information (whether stored, such as in a file, or streamed), photos and other images, music and other audio information (whether stored or streamed), presentations, video/teleconferences, videogames, Internet Web pages and other data, and other similar video or audio content. As used herein, “content presentation devices” include, but are not limited to, televisions, stereos, monitors, flat panels, projectors, cellular telephone telephones, portable audio players (e.g., MP3 players), portable video players (e.g., portable DVD players or Video iPods™), personal computers (whether a desktop, laptop, or a tablet PC), PDAs (“Personal Digital Assistants”), wireless handsets, electronic organizers, portable email machines, game machines, pagers, navigation machine such as GPS receivers and other similar devices capable of presenting video and/or audio content. As used herein, devices for receiving and/or distributing content include, but are not limited to, STBs, DVRs or PVRs, media centers, DVD players and VCRs.

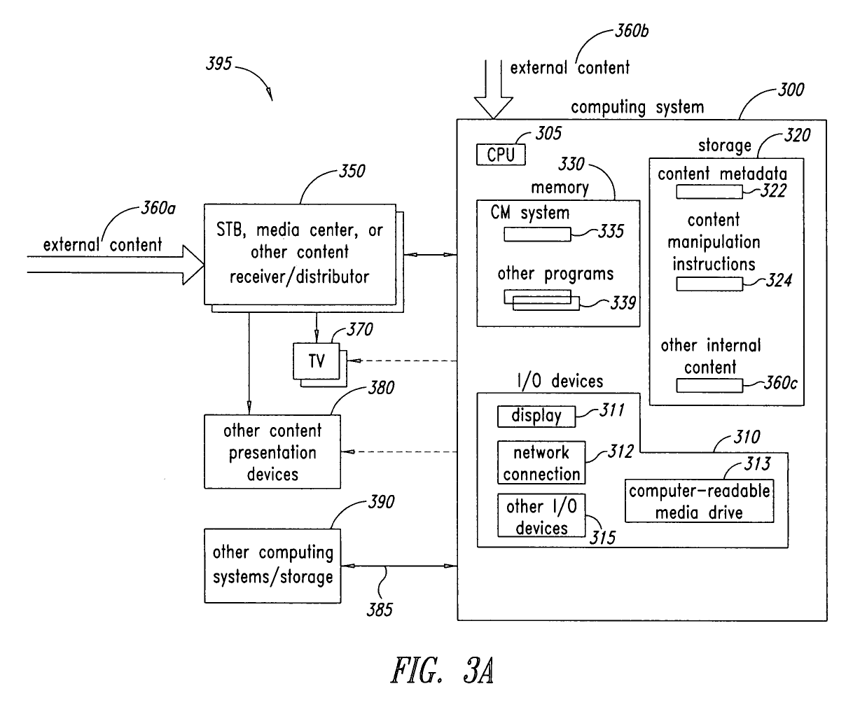

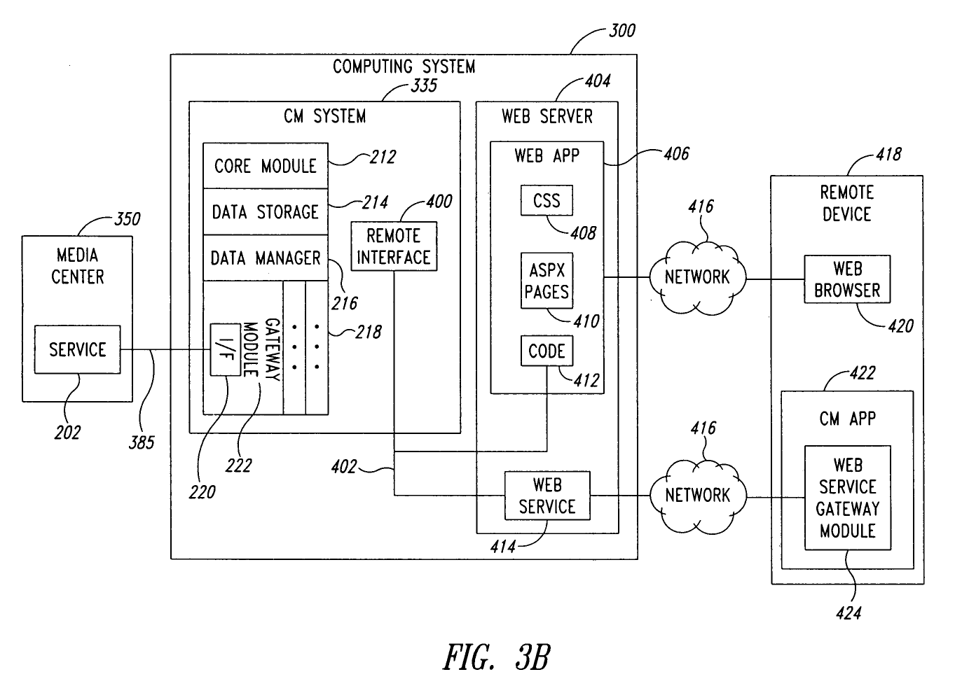

FIGS. 3A-3B are block diagrams of example embodiments of environments of the CM system. In particular, FIG. 3A is a block diagram illustrating an example of use of an embodiment of the CM system in a home environment 395 for entertainment purposes, although the CM system could similarly be used in business or other non-home environments and for purposes other than entertainment. In this example, the home environment includes an STB or other media center 350 that is able to distribute content to content presentation devices, such as after receiving external content 360a that is available to one or more consumers (not shown) in the environment (e.g., television-related programming content 360a for presentation on a television 370). Other types of audio and/or video content could similarly be distributed by the media center 350 for presentation to the consumer(s) on the television and/or optional other content presentation devices 380 in the environment, such as stored content or other external content that is received.

The home environment also includes an example computing system 300 suitable for executing a software embodiment of the CM system, as well as one or more optional other local computing systems and/or storage devices 390 with which the computing system 300 can interact via local network 385—while not illustrated here, the computing system 300 and executing CM system may further optionally interact with one more other remote computing systems and/or storage devices (not shown) via an external network (not shown). In the illustrated embodiment, the computing system includes a CPU 305, various I/O devices 310, storage 320, and memory 330, and the I/O devices include a display 311, a network connection 312, a computer-readable media drive 313, and other I/O devices 315 (e.g., a keyboard, a mouse, a pointing device, speakers, etc.). In some embodiments the computing system 300 may further interact with one or more external computing systems (not shown), such as via the Internet and/or the World Wide Web, such as to receive additional external content 360b and/or other information or services.

In the illustrated embodiment, the computing system 300 interacts with the media center 350 in a variety of ways, including receiving information about current and/or future television-related programming content 360a and/or other content 360a. In this example, the information received by the computing system 300 includes EPG metadata information for the television-related programming content (e.g., from a cable network operator), and can further include a variety of other types of metadata for the content 360a, whether from the cable network operator or other third-parties (e.g., from various external computing systems, not shown, such as via external content 360b). This received content metadata is then stored in a content metadata database 322 in the illustrated embodiment for use by the CM system.

An embodiment of the CM system 335 is executing in memory. As discussed in greater detail below, the CM system provides information about the available content to one or more users, such as via a GUI displayed on the display device 31 1 and/or on one or more of the content presentation devices 370 or 380 or other computing systems 390. For example, the CM system may provide some or all of the stored content metadata 322 to the users, and also allow the user to manipulate the content in a variety of ways (e.g., to select an indicated piece of content for current presentation, to select a group of related content items for presentation via a playlist, for future recording, etc.). As the user provides instructions related to manipulation of the content, those content manipulation instructions are in the illustrated embodiment stored in a database 324 on storage 320 for later retrieval and use by the CM system, and at least some such content manipulation instructions may additionally in some embodiments be provided to the media center 350 for use in actually performing the tasks to satisfy the manipulation instructions. In addition, in some embodiments the CM system may also interact with other executing programs in order to provide additional information and/or functionality to the user(s), such as one or more optional executing other programs 339 in memory 330 or instead remote executing programs on another computing system.

In the illustrated embodiment, the CM system does not itself present the external content 360a to the user(s), instead interacting with the media center 350 to control the display of the content to the user via the TV and/or one or more of the other content presentation devices. However, in other embodiments the CM system may instead receive some or all of the external content 360a, whether via the media center 350 or instead directly from the source of that content, and if so could directly control the presentation of that content to the user(s) on the display device 311 and/or other content presentation device 370 or 380 or other computing system 390. Conversely, in the illustrated embodiment the computing system 300 may have access to additional content, such as external content 360b (e.g., additional content related to the external content 360a but from another source), locally stored other content 360c on storage 320, and/or other locally accessible content (not shown), such as from one or more of the other computing systems/storage devices 390—if so, the computing system 300 may in some embodiments directly present some or all of that content to the user(s), such as on display device 311 (e.g., as part of the CM system GUI) and/or on one or more other content presentation devices 370 or 380 or other computing system 390, while in other embodiments may present some or all of that content to the user(s) by instead interacting with the media center 350 to facilitate the presentation (e.g., by providing the additional content to be presented and/or associated instructions to the media center).

The functionality of the CM system may be accessed in various ways in different embodiments. For example, some users may have physical access to the computing system 300, and if so can interact with the various I/O devices 310 to provide and/or receive information. Alternatively, other users can use other client computing devices to remotely access the CM system, such as other local computing systems 390 or instead remotely (e.g., via the Internet and/or the World Wide Web, via a cellular or other telephone network, etc.). Such remote users may use software or other functionality provided on the client computing systems (not shown), such as a Web browser or specialized client application, to interact with the CM system. In other embodiments, users may instead receive functionality and/or information from the CM system indirectly via interactions with one or more other devices, such as the media center 350, which may directly receive that functionality or information from the CM system before providing it to the users.

For example, in some embodiments the computing system 300 and/or one of more of the computing systems 390 is a cellphone (e.g., a smartphone) or other mobile or handheld device with communications capabilities (e.g., a Pocket PC computer, a PDA, an electronic organizer, etc.), and if so the user may use that device to manage content in various ways. In these embodiments, the communications between the cellphone or other device and other computing systems and devices may occur in various manners. For example, some devices may support various types of local communication mechanisms (e.g., wireless communications via Bluetooth, Wi-Fi, direct infrared, etc.) and/or communication mechanisms that may be used remotely (e.g., if the device supports Internet access, such as via GPRS or WiMax and using HTTP or WAP, or instead using a standard telecommunications link/network for exchanging voice and other audio information), and may further support various communication and messaging protocols (e.g., Universal Plug-and-Play (or “UPnP”), Home Audio Video Interoperability (or “HAVI”), etc.). When a device supports both local and remote communication mechanisms, the device may further be configured to seamlessly switch between local and remote communications as appropriate, such as to automatically use local communications when they are available and to use remote communications otherwise, or instead may use various communications as directed by the user, and in some embodiments the device may alter functionality that is provided based on the particular communication mechanism that is in use (e.g., to only provide functionality to allow the device to act as a remote control for another content presentation device or content distribution device if the device is local to that other device). Remote communications may be appropriate, for example, when the device is remote from the home environment (e.g., outside a building that contains the home environment, not shown, such as at significant distances), such as to perform some or all data exchange via Internet access and/or using voice commands over a standard telecommunication link. In addition, various types of devices may have varying communications abilities, and thus devices in various embodiments may use different forms of communication for a single type of information exchange.

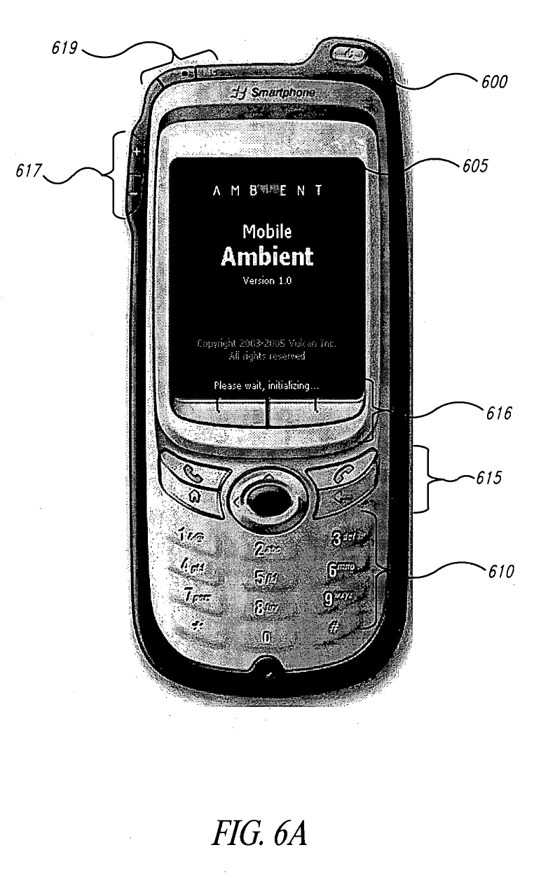

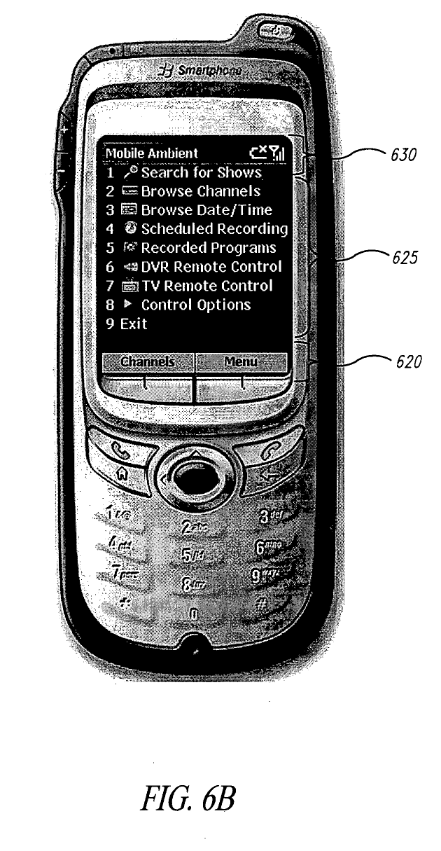

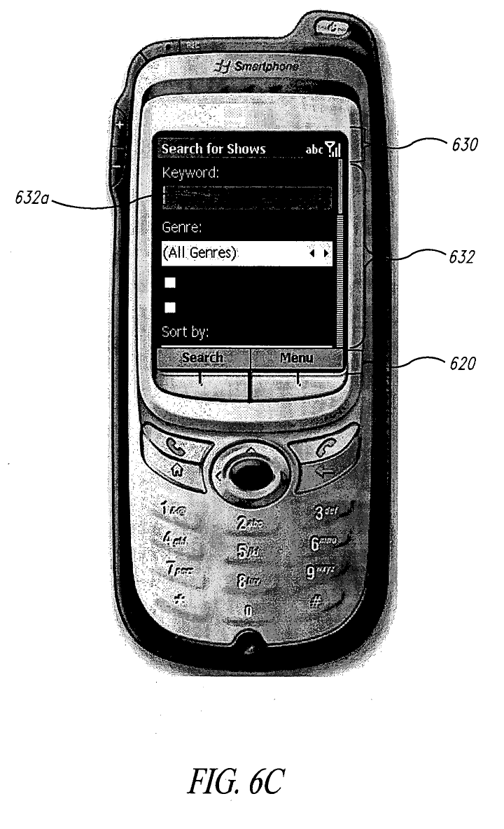

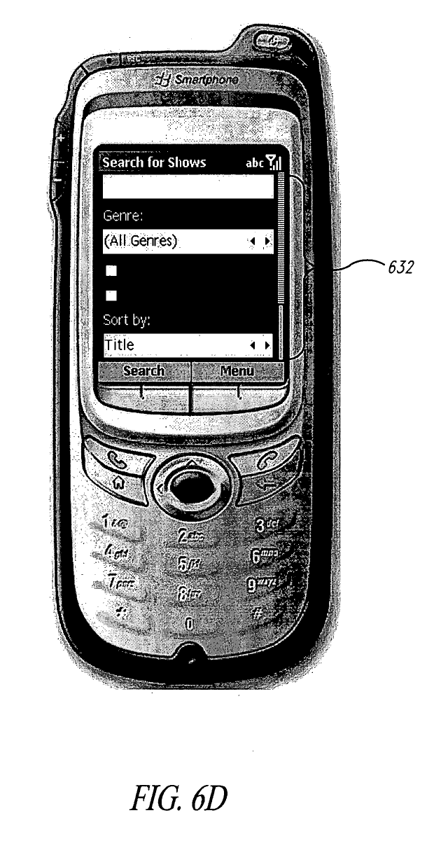

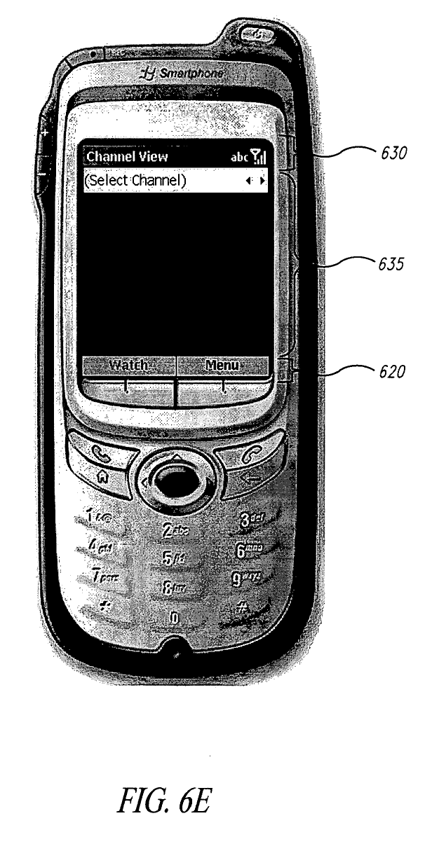

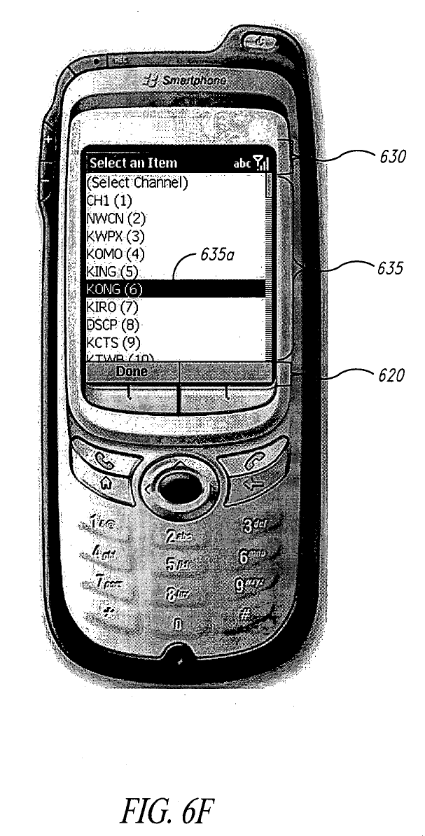

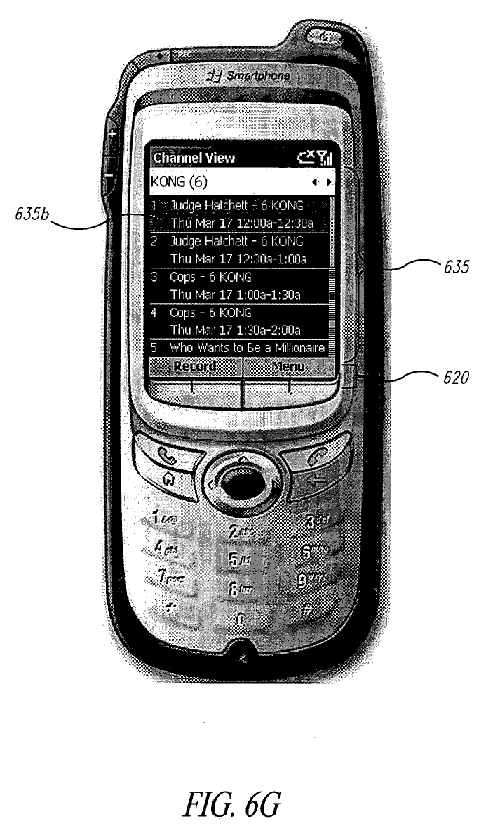

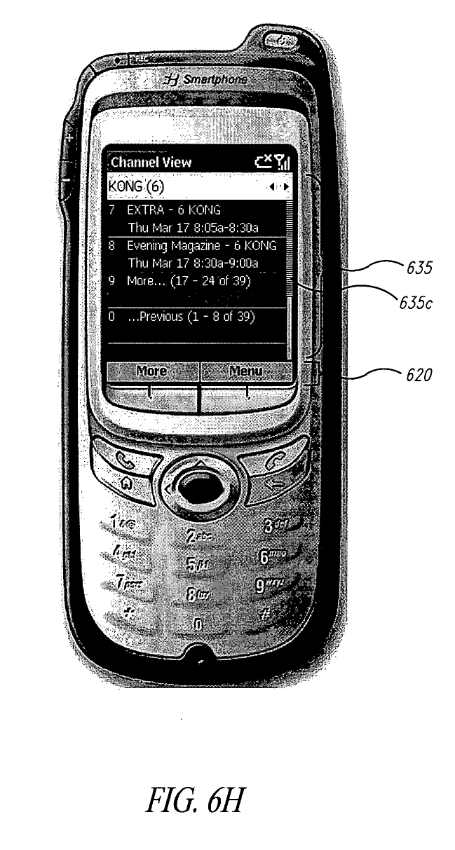

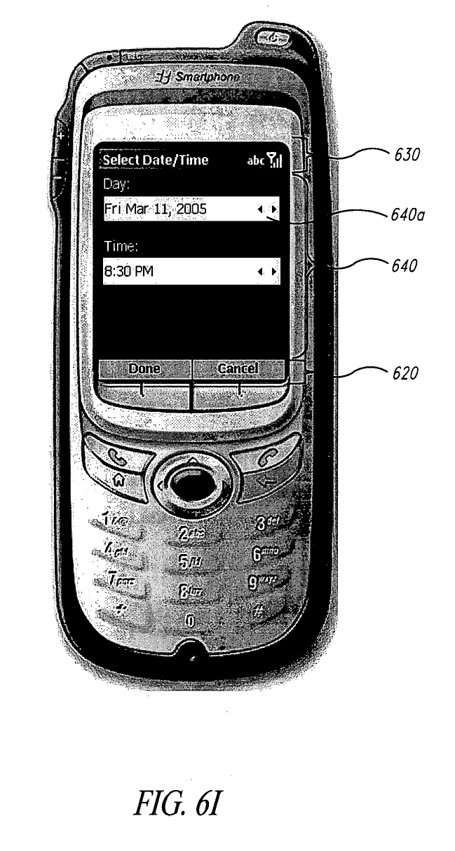

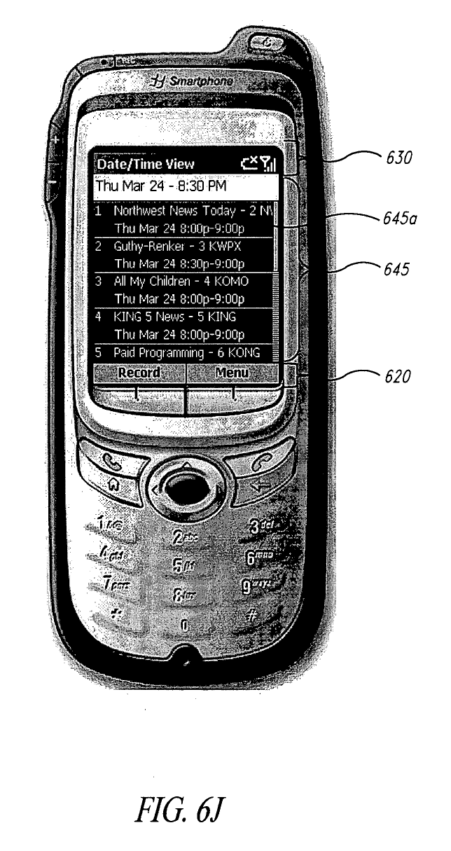

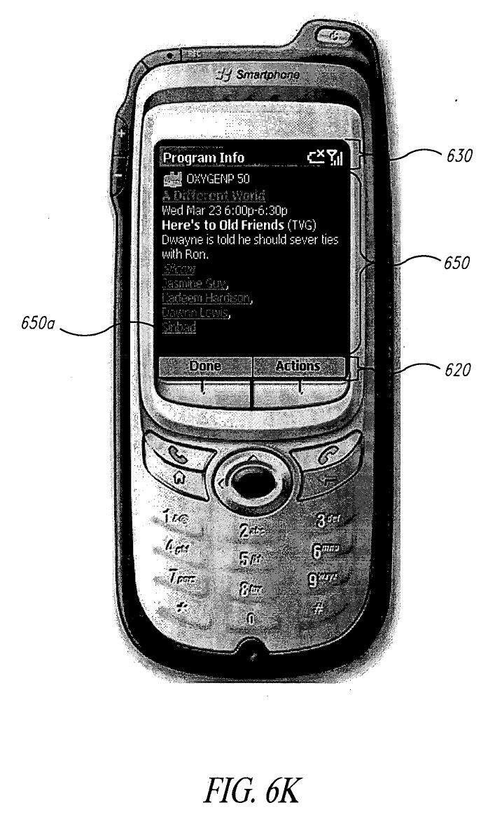

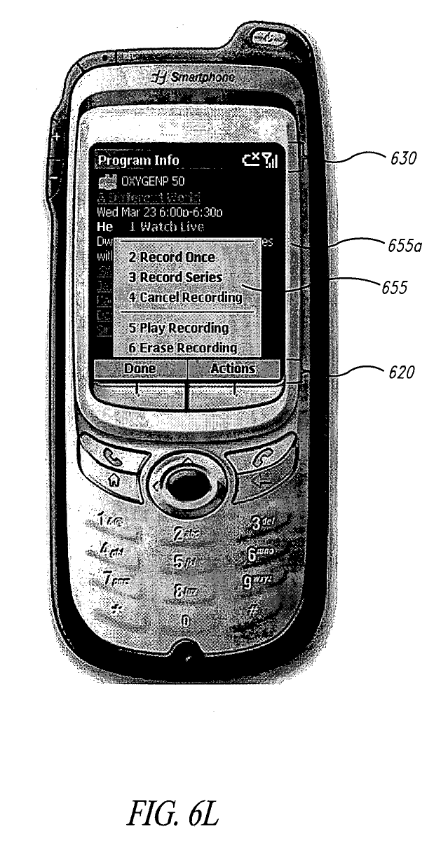

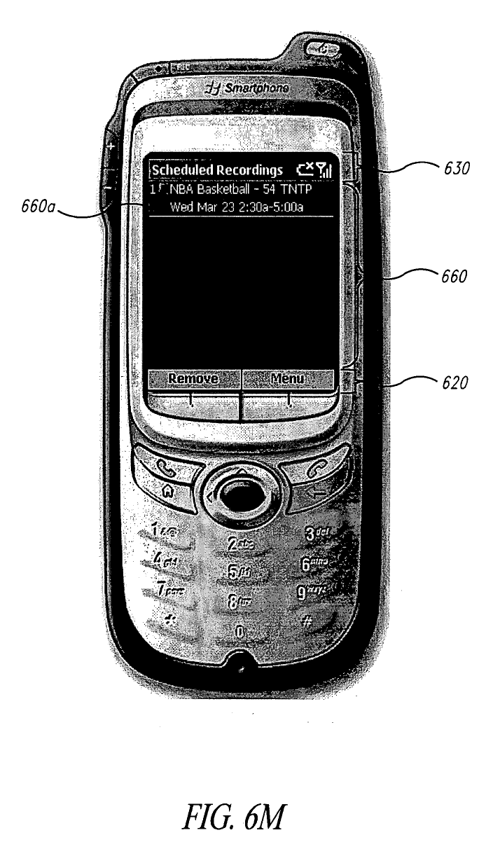

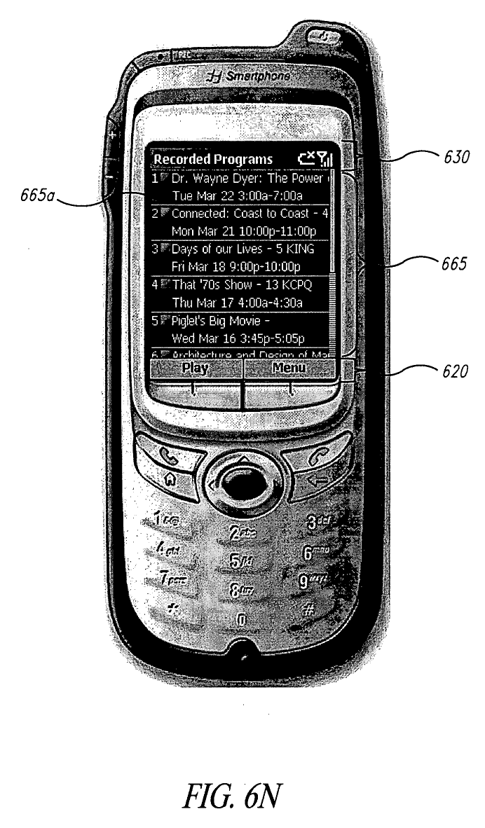

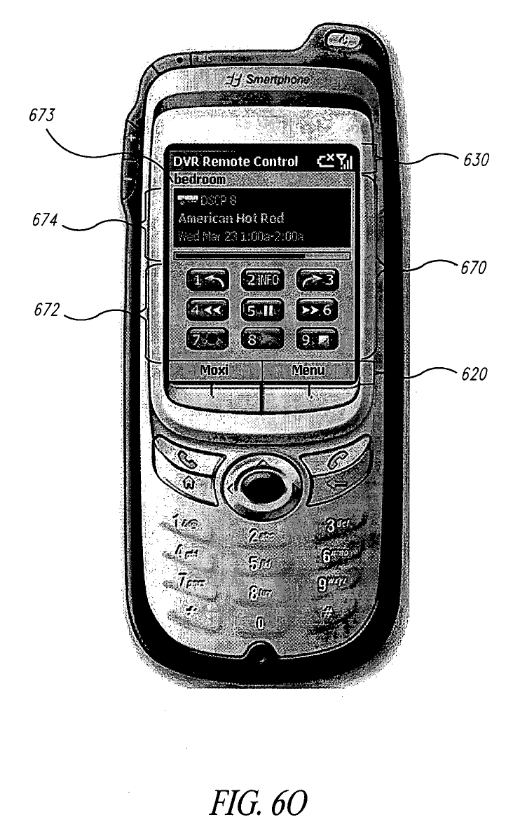

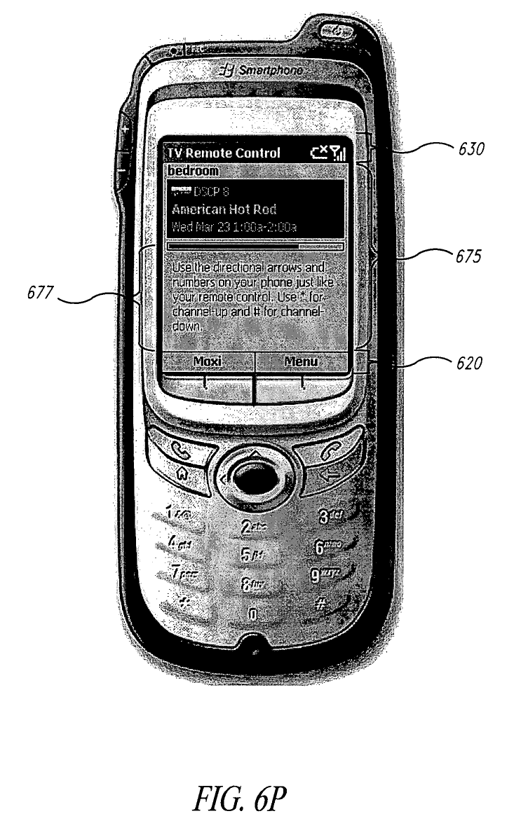

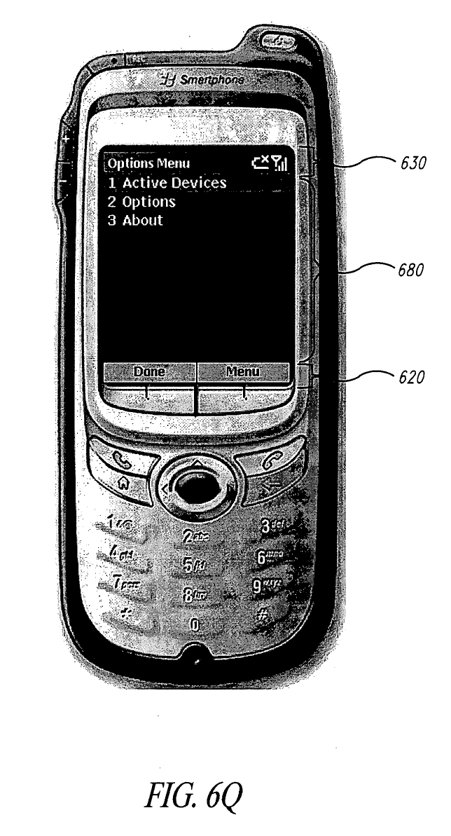

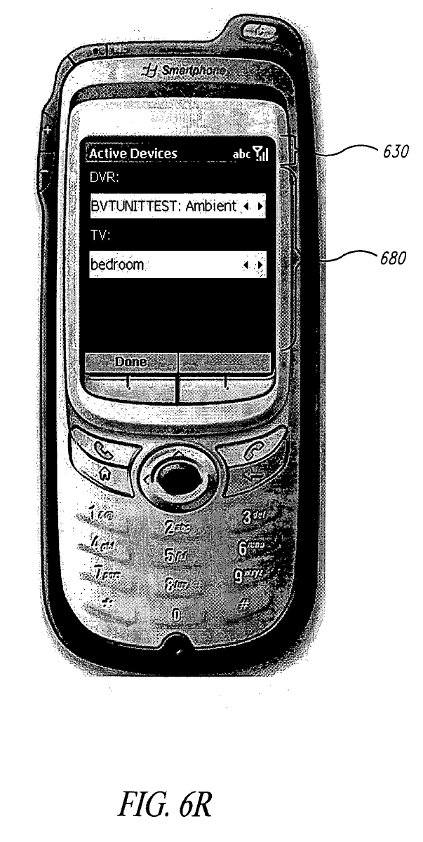

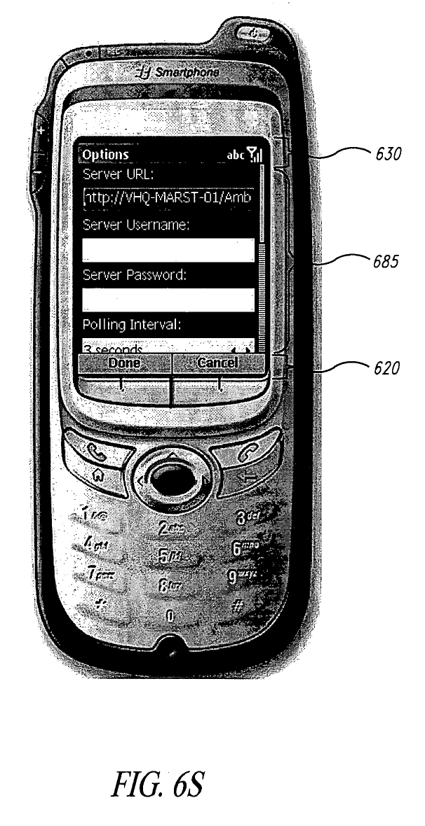

When a user uses a cellphone or other mobile or handheld device to manage content, various types of information may be exchanged in various ways. For example, software to implement at least a portion of the CM system on the device and/or to interact with a remote executing CM system may be preinstalled on the device when provided to the user (e.g., by the distributor of the device) and/or may be downloaded to the device after the user has the device (e.g., as an executable file from another local computing system to which the device has a physical or wireless connection, or directly from a remote Web site if the device supports Internet access). EPG and/or other types of metadata may similarly be provided to the device in various ways, such as via Internet access to a local computing system (e.g., computing system 300) and/or a remote computing system, from a local computing system and/or media center device 350 via local communication mechanisms, and/or based on occasional periodic physical docking or other connections with other devices. Commands and other information from the user may similarly be provided from the device to computing systems and other devices in the home environment in various ways, including via Internet access and/or local communication mechanisms. FIGS. 6A-6S provide examples of a GUI and related capabilities that may be used in some embodiments with a cellphone or other device with a limited display screen and/or limited input device capabilities (e.g., a device without an alphanumeric keyboard), as discussed in greater detail below.

FIG. 3B is a block diagram illustrating an embodiment of the CM system 335 that provides capabilities to allow it to be remotely accessed via a network, such as via a remote device that includes user interface capabilities corresponding to the CM system. In particular, in the illustrated embodiment the CM system 335 includes a remote interface 400 to allow external devices to interact with the CM system, such as to provide access to other elements 212-222 of the CM system such as were described with respect to FIG. 3A—while not illustrated, the CM system may further include a GUI module to allow one or more users local to the computing system 300 to interact with the CM system via a local GUI, such as simultaneously with one or more remote users. A variety of types of remote procedure call (“RPC”) or similar intercommunication mechanisms may be employed for communications 402 to the CM system from an external remote device 418 (e.g., a mobile device) via an interface 404, which in this example is provided on the computing system 300.

The interface 404 in this example is a Web server, which may be separate from or part of the CM system 335, and in this example includes both a Web service 414 that exposes the remote interface 400 to a network 416 (e.g., a wireless and/or wired/cabled hardwire network, such as the Internet, a WAN, a LAN, a telecommunications company network, and/or other type of network), and a Web application 406 (which in this example provides a Web-based GUI front-end for the CM system 335 for display on remote devices) to provide remote users on the network 416 with capability to access and use the CM system 335 via the Web-based GUI. In other embodiments, only one of the Web service and Web application may be used for remote access, or instead other types of remote interaction mechanisms may be used. The Web application 406 in this illustrated embodiment includes Cascade Style Sheets (“CSS”) 408 that may be used to generate and change the look-and-feel of the Web-based GUI, ASPX pages 410 to support its operation, and code 412 to provide communications 402 between the Web application 406 and the remote interface 400 of the CM system 335. In other embodiments, a separate Web-based GUI may instead not be provided, such as if remote users receive the same GUI as would local users, or if some or all types of remote devices use a remote GUI that is tailored or customized based on capabilities of the device (e.g., by varying formatting and/or amount of data provided), such as for devices with limited display area, connection speed and/or processing power (e.g., mobile devices).

As noted, the Web-based GUI of the Web application 406 and/or the Web service 414 are provided over the network 416 to one or more remote devices 418 via various communications, and a variety of types of communication protocols may be used on the network 416 for the communications, including (without limitation) HTTP, HTTPS, SOAP, and/or other communication protocols. Examples of a remote device 418 may include various types of mobile devices (e.g., a laptop, PDA, cellular telephone, Blackberry, GPS device, tablet or other mobile wireless device), as well as various types of stationary computing devices (e.g., a personal computer (PC), workstation, and so forth).

The illustrated embodiment of the remote device 418 includes a Web browser 420 (or other type of browser or application) that is suitable to communicate with the Web server 404 and to render the Web-based GUI provided by the Web application 406. For instance, the user may use the Web browser 420 to access an interactive Web page and/or Web site where the Web-based GUI is provided and accessible, such as to allow the user to enter (or view) commands and data. Alternatively, the remote device may include a CM client application 422 to communicate with the Web service 414 using a gateway module 424, such as a plug-in module for the CM application. In this example embodiment, the user may generate control requests and data requests using one or both of the Web-based GUI and the CM application, with such requests then communicated to the remote interface 400 via the Web server so that the appropriate operations may be performed by the elements 212-222 of the CM system 335 to fulfill the requests. In addition, while not illustrated here, in other embodiments the Web browser 420 may execute a Web page from Web application 406 containing an embedded application (e.g., using ActiveX, Java applet, client-side JavaScript, etc.) that provides at least a portion of the CM system functionality and that can interact with Web service 414.

Those skilled in the art will appreciate that computing system 300 is merely illustrative and is not intended to limit the scope of the present invention. For example, the computing system may instead be comprised of multiple interacting computing systems or devices, and may be connected to other devices that are not illustrated, including through one or more networks such as a LAN, the Internet or via the World Wide Web (“Web”). More generally, the computing system 300 and/or the other computing systems 390 may each comprise any combination of hardware or software that can perform the described techniques, including (without limitation) desktop or laptop or other personal computers, network devices, Internet appliances, PDAs, wireless phones, cellphones, devices with walkie-talkie and other push-to-talk capabilities, pagers, electronic organizers, television-based systems and various other consumer products that include appropriate inter-communication and computing capabilities. In addition, the functionality provided by the CM system may in some embodiments be distributed in additional systems, and the CM system may have multiple components that each provides a portion of the functionality of the system. Similarly, in some embodiments some of the illustrated types of functionality of the CM system may not be provided and/or other additional functionality may be available.

Those skilled in the art will also appreciate that, while various items are illustrated as being stored in memory or on storage while being used, these items or portions of them can be transferred between memory and other storage devices for purposes of memory management and data integrity. Alternatively, in other embodiments some or all of the software system (or portions of it) may execute in memory on another device and communicate with the illustrated computing system via inter-computer communication. Some or all of the system and/or data structures (e.g., portions of a database, such as one or more tables or views or portions thereof) used by the system may also be stored (e.g., as software instructions or structured data) on a computer-readable medium, such as a hard disk, a memory, a computer network or other transmission medium, or a portable media article (e.g., a DVD or flash memory device) to be read by an appropriate drive or via an appropriate connection. Some or all of the system and data structures can also be transmitted via generated data signals (e.g., by being encoded in a carrier wave or otherwise included as part of an analog or digital propagated signal) on a variety of computer-readable transmission mediums, including wireless-based and wired/cable-based mediums, and can take a variety of forms (e.g., as part of a single or multiplexed analog signal, or as multiple discrete digital packets or frames). Such computer program products may also take other forms in other embodiments. Accordingly, the present invention may be practiced with other computer system configurations.

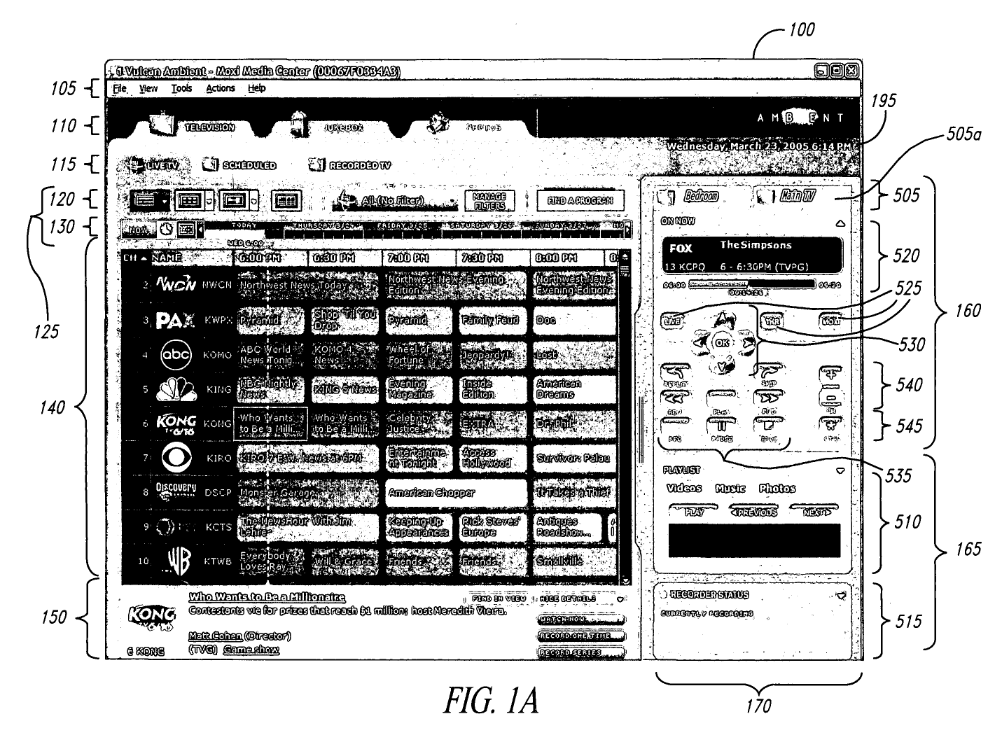

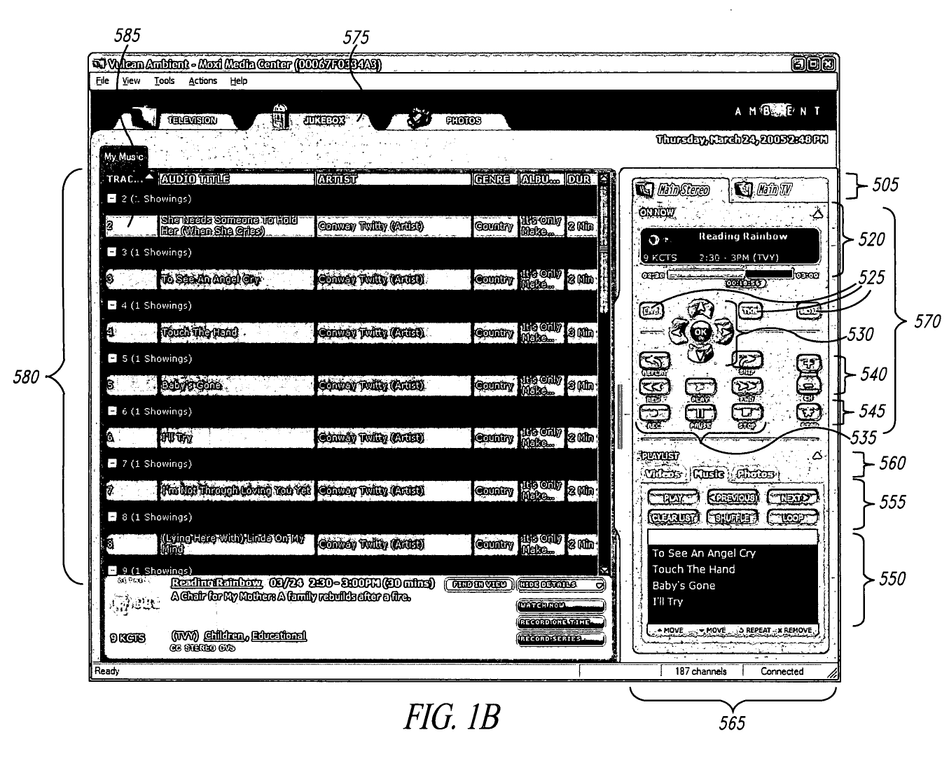

FIGS. 1A-1B are example embodiments of a GUI for a CM system, including a variety of information and user-selectable controls. While specific layouts and formats are shown in FIGS. 1A and 1B, such specific details are not intended to be limiting or exhaustive. Similarly, while specific types of devices are illustrated as being currently controlled or otherwise managed via the GUI, a variety of other types of content presentation control devices and other media devices, as well as other electronic devices, may similarly be associated with and managed via the GUI in other embodiments.

In particular, FIG. 1A illustrates an example GUI 100 embodiment that displays program listing information for live TV in a view area 140, with the displayed listings initially based on a current time 195. The TV listings in the view area 140 are initially shown in a grid format, with columns of the grid corresponding to successive time units of thirty minutes each and with each row corresponding to a different TV channel that may show one or more TV programs during the displayed time period. The GUI also includes a variety of other areas, including a menu bar 105 with dropdown menus, primary content-type navigation tabs 110, secondary content-type-specific navigation tabs 115, a view control area 125 that includes view and filter controls 120 and time controls 130, a detail area 150, and a status control sidebar area 170 that includes virtual remote control functionality 160 and a user-focused content summary area 165. While not illustrated here, in some embodiments the GUI may further have a status bar display area along the bottom of the GUI below the detail area and status control sidebar area. The view control area 125 also includes a first timebar that corresponds to a relatively long first time period at a first time scale (which is selected based in part using time controls 130) and that may in certain situations display limited information about content (although in this example the first timebar does not display any limited information about any television programs or other content), while the view area 140 illustrates detailed information about content for a relatively short second time period at a second time scale, with a second timebar rendered at the top of the view area 140. Additional details related to example GUI functionality and capabilities in at least some embodiments are included in U.S. Provisional Patent Application 60/667,836, filed Apr. 1, 2005 and entitled “Interface For Manipulating Multimedia Content,” in U.S. Provisional Patent Application 60/677,059, filed May 2, 2005 and entitled “Interface For Manipulating Multimedia Content,” and in U.S. patent application Ser. No. 11/120,664, filed May 2, 2005 and entitled “Maintaining A Graphical User Interface State That Is Based On A Selected Piece Of Content,” each of which is incorporated herein by reference in its entirety.

The example GUI 100 also illustrates a variety of controls and information 505-545 in the status control sidebar area 170, such as to provide virtual remote control capabilities in order to control recording of content on multiple devices (e.g., multiple devices with DVR capabilities) and/or presentation of content on multiple devices (e.g., multiple televisions, multiple stereos). For example, the illustrated sidebar area contains multiple user-selectable device control tabs 505, with each tab representing a device that can be controlled, such as with respect to presenting content and/or recording or otherwise obtaining content for later presentation. In this example, two television devices are available to which live or previously recorded content can be directed, with the “Main TV” device currently selected as indicated by tab 505a. The current content information section 520 indicates that “The Simpsons” television programming is currently being directed to the “Main TV” television device for presentation, while other content (not shown) may be being directed to the “Bedroom” television device. In some embodiments, controls may be sent directly to the device being controlled (e.g., by directing the “Main TV” television device to change channels), while in other embodiments one or more intermediate devices may be involved in the controls (e.g., by directing an STB, not shown, to control live television content sent to the currently selected television device and/or by directing a DVR, not shown, to direct recorded television content sent to the currently selected television device). Moreover, in some embodiments one or more such intermediate devices may each be able to interact with and/or control multiple presentation devices, such as to have a single STB and/or DVR control content being provided to two television devices (e.g., by using a MOXI device that provides such functionality).

Content to be directed to a currently selected device may be selected in various ways. For example, user-selectable channel controls 540 are shown for manipulating a current channel, and in other embodiments other controls (e.g., user-selectable numeric buttons, not shown) may be available for specifying a particular channel. In addition, in the current embodiment various program listing information for live TV is shown in a separate view area in grid format, and additional information is displayed in the detail area for a “Who Wants to Be a Millionaire” television program that is currently selected in the view area—in this embodiment, a user-selectable “Watch Now” control in the detail area may be selected to cause the currently selected program to be directed to the currently selected television device, and similar functionality may be available for some or all of the television programs indicated in the view area (e.g., via a pop-up menu). The illustrated embodiment of the sidebar also includes a user-focused content summary area 515 related to upcoming recordings and previously recorded programs, and while a display of previously recorded programs in section 515 is not illustrated here, a displayed previously recorded program may be selected for current presentation on the currently selected television device (e.g., via instructions sent to a DVR or other storage device on which that program is stored).

A playlist section 510 is also shown in the illustrated embodiment, although no content is displayed in this example for a current playlist. In at least some embodiments, content of various types may be selected for inclusion in one or more such playlists, and content displayed in a playlist in section 510 may similarly be selected for current presentation on the currently selected television device (e.g., via instructions sent to a DVR or other storage device on which that program is stored). In the illustrated embodiment, content in playlists may include various forms of content, such as video information (e.g., television programming), digital music, photos and other images, etc. In some embodiments, the device that is currently selected for control may affect the information in the playlist section in various ways, such as to select a current playlist based on a current device being controlled (e.g., based on the type of device, such as to select a playlist having video information when the device being controlled is a television device) and/or to enable content for current selection only if appropriate for the currently selected device (e.g., to disable video or image information if the currently selected device is a speaker, but to allow video, images and music to be presented on at least some types of television devices, such as based on capabilities of the device). Additional details about playlists are discussed below.

The illustrated embodiment of the sidebar control area also includes a variety of other controls related to content being presented and to other types of user instructions that may be provided. For example, various user-selectable controls 525 may affect the type of content being presented from among various sources, such as live television programming (e.g., from a cable company or satellite provider), a menu or other functionality from a DVR, and a ticker on at least a portion of the display of the currently selected television device (e.g., with headline news, such as from a cable company or from a provider associated with the DVR). Various interactivity controls 530 may further allow the user to make various selections, such as from a menu or from among multiple options. Various controls 535 may also be used to control the presentation of content, such as to pause presentation, skip backward, skip forward (when available, such as with other than live content) and rewind or fast forward, as well as to provide an instruction to record content that is currently being presented. One or more specialized controls 545 may also be provided, such as to correspond to functionality that may be available on only certain devices, such as on certain types of STBs and/or DVRs.

FIG. 1B illustrates additional controls and capabilities to allow a user to define and use one or more “playlists” that each may have one or more pieces of content to be recorded and/or are available for playback or other presentation.

In this illustrated embodiment, the user-selectable device control tabs 505 include a currently selected “Main Stereo” stereo device, as well as a “Main TV” television device, and a current playlist selection section 550 includes various user-selectable music selections in a current playlist. In the illustrated embodiment, the playlist section also includes various user-selectable playlist type control tabs 560, with a “Music” type control tab being currently selected—in other embodiments, playlists may be organized in other manners, such as to have a single playlist that includes content of various types.

Content in a playlist may be controlled in various ways in various embodiments, including by selecting and manipulating individual pieces of content within a playlist and/or by treating some or all of the content in a playlist as a group. In some embodiments, some or all of the user-selectable controls in section 570 may be used to control presentation of a current playlist and/or of a currently selected piece of content in the current playlist. In addition, the illustrated embodiment includes a variety of user-selectable controls that are specific to playlists, such as controls 555 for controlling how content within the currently selected playlist is presented (e.g., to move to a previous or next piece of content in the list, to clear the list, to play a current selected piece of content, to play the content in the currently selected playlist in shuffle mode, to repeatedly loop through presentation of the content in the currently selected playlist, etc.), and controls 565 for altering the arrangement and contents in the currently selected playlist (e.g., to move contents items up or down in the current playlist, to remove content items from the current playlist, etc.), as well as to cause presentation of a currently selected piece of content to repeat.

Content can be selected for inclusion in a playlist in various ways, and playlists may be created and maintained in various ways (e.g., maintained indefinitely until the user otherwise modifies or removes the playlist, or instead in a temporary manner, such as for a specified period of time and/or until storage space is needed for other purposes). In the illustrated embodiment, the view area 580 includes a listing of various pieces of musical content that is scheduled to be presented at various current and/or future times. In some embodiments, a piece of content may be selected from the view area and added to a current playlist and/or a user-specified playlist, such as via a pop-up menu (not shown). For example, a currently selected “She Needs Someone To Hold Her” song 585 may have been just added to the current playlist based on a user instruction, and in other embodiments music may be presented and selectable in other manners and/or other types of content (e.g., other types of audio information, television programming and other video, photos and other images, etc.) may similarly be presented and selectable in various manners. In addition, while not illustrated in the current example, in some embodiments one or more user-selectable controls may be provided in the detail area, such as to allow a currently selected item to be selected to a current playlist and/or a user-selectable playlist (e.g., from a list of playlists). In some embodiments, only currently presented content may be available to be added to a playlist, while in other embodiments content that is scheduled for later presentation may be added to a playlist and automatically recorded at that time—in such latter embodiments, content in a playlist that is not currently being presented and is not yet recorded may be treated differently than other content in the playlist, such as to prevent the content from being selected for current presentation on a currently selected device being controlled. In addition, content may be able to be selected for playlists in other manners in other embodiments, such as by downloading content from a remote computing shown (not shown) via the Internet or other mechanism. While not illustrated here, content may further be organized in various manners, such as in manners selected by the user (e.g., by allowing the user to specify names for playlists, to organize the playlists in various ways, to associate playlists with each other and/or with devices (or groups of devices) available to be controlled (e.g., specific devices and/or types of devices).

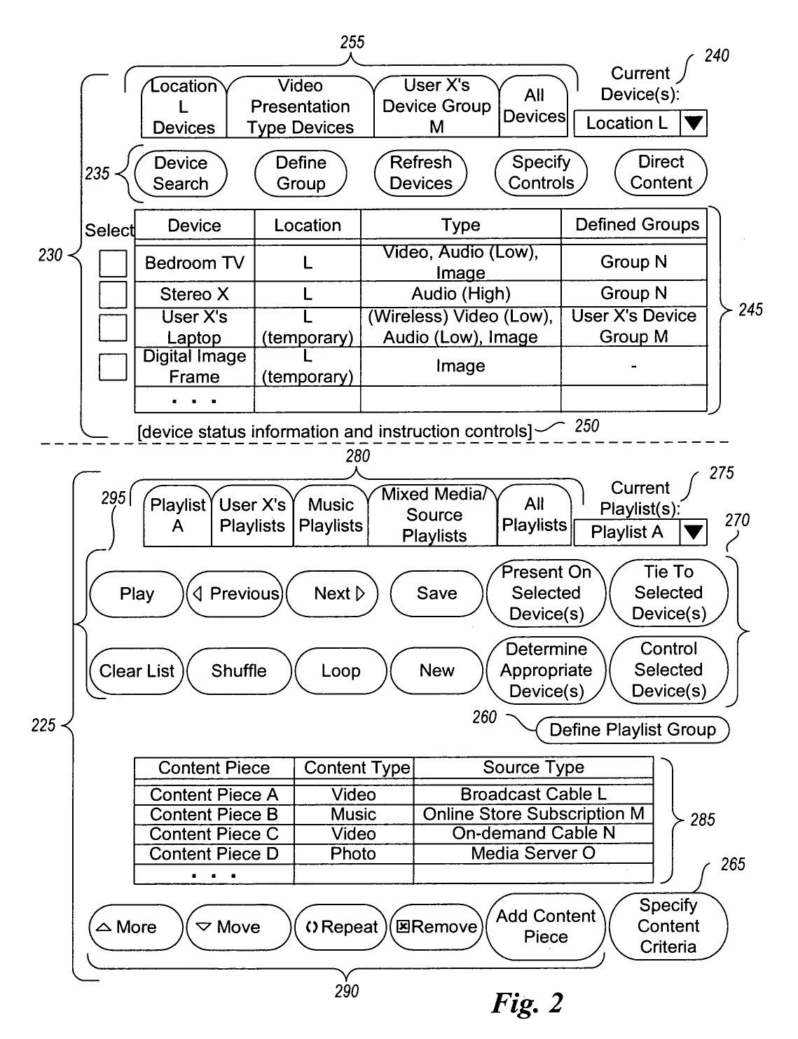

FIG. 2 is an example embodiment of a portion of a GUI for use in controlling groups of devices and managing playlists, such as via a GUI status and control sidebar area for controlling groups of devices and managing playlists. In some embodiments, the illustrated GUI portion may be used in addition to or instead of the status control sidebar 170 of FIG. 1A.

In the illustrated embodiment, the GUI includes a device control area 230 and a playlist control area 225. The device control area includes various controls 235 for managing devices, other controls 250 for controlling and displaying status of individual devices (e.g., controls and information similar to elements 520-545 in area 570 of FIGS. 1A and 1B, including to act as a virtual remote control for one or more devices), device group selection tabs 255, a user-selectable list control 240 for selecting individual devices and/or groups of devices, and a section 245 that lists various details about devices that are in a currently selected group. In other embodiments, only one of the tabs 255 and list control 240 may be provided, and a variety of other types of controls 235 may be included. In addition, while not currently illustrated, in some embodiments a particular device may be selected, and a variety of additional device-specific details may be displayed (whether instead of or in addition to the device group details in section 245). In the illustrated embodiment, devices may be grouped together in various manners, such as based on the location of the devices, type of the devices, types of content presentation capabilities of the devices, types of capabilities for using DRM technologies, based on a user-specified group of devices or for devices that are otherwise associated with a user, etc., and at least some such groups may be automatically and dynamically determined (e.g., by automatically determining all devices matching indicated criteria for the group when the group is selected).

In this example, the controls 235 for managing multiple devices include a number of user-selectable buttons, including to perform a device search, to define a device group, to refresh devices that are part of a group, to specify parental access controls and other usage controls, and to direct content to one or more particular devices (e.g., to the devices of a device group). For example, when a user selects the “Specify Controls” button, the user may be able to configure parental controls and other types of access/usage controls for one or more devices, such as devices selected from the list of devices in section 245 or for all devices of one or more device groups. As one example, the user may in some embodiments specify user-based controls for a device (e.g., by using a password or PIN or other access code for access control), while in other embodiments the users may specify timing-related controls (e.g., to turn a device off at an indicated time or to otherwise make the device unavailable) or other types of controls. In situations in which a device is protected by user-based controls, such as an access code, a user who attempts to make use of the device (e.g., to present content on a content presentation device protected by an access code) may be prompted to supply an appropriate access code or other similar information in order to gain access to the device. When a user selects the “Direct Content” button, one or more pieces of content may be directed to be presented on one or more devices in the group, such as one or more selected devices, and with the content to be directed being based on a currently selected piece of one or more contents (e.g., from a playlist in section 225) and/or based on content that is selected by the user after the user is prompted to browse or otherwise indicate the content in response to the button selection (e.g., from among all available content, or from playlists and/or other content that is tied to or otherwise associated with the device group and/or one or more selected devices).

In some embodiments, a device search initiated by the “Device Search” button allows a user to search for available content presentation devices, such as devices that match one or more criteria specified by the user (e.g., in response to prompts provided to the user after selection of the button), such as location, device type, having capabilities to present indicated types of content, having digital rights management (“DRM”) capabilities of indicated types, having other user-indicated attributes, etc. For example, the search may check all known or available devices (e.g., content presentation devices and/or other types of devices) to determine whether the devices satisfy any criteria (if indicated), or more generally whether the devices are available (e.g., currently present and/or turned on and/or not busy at other tasks). The “Refresh Devices” control in this example may update a previously performed search and/or may update a currently selected group of devices, such as to look for devices that may have been added or removed since the last time devices were refreshed (although in some embodiments, devices may instead be refreshed automatically, such as at periodic intervals or when the devices report any changes), or to determine a current status of previously known devices. Portable or mobile devices that are able to change location may include content presentation devices that are transient and only temporarily associated with a location and/or with the CM system, or may more generally include other types of devices. As the CM system scans for or otherwise locates devices, groups of devices may be automatically created in at least some embodiments (e.g., all devices in the same location, all devices of a particular type, etc.). In addition, a user may manually define or modify a group of devices, such as via the “Define Group” control, such as to manually specify a device to be included in a group or to exclude a device from a particular group of devices or from use/association with the CM system. For example, a user may specify that even though a laptop is temporarily in the bedroom, it is not to be used as a content presentation device or is not to be included in the bedroom location group of devices. Additional details relating to some of the functionality of the controls are discussed below. In addition, in some embodiments device groups may include devices other than content-related devices, such as devices related to home automation (e.g., to control the lights in a location, such as in a manner coordinated with content presentation activities that are being performed), whether directly by the CM system or in coordination with a separate home automation system (not shown). Additional details related to interacting with various types of devices are included in U.S. patent application Ser. No. 11/120,653 (Attorney Docket No. 931086.408), filed May 2, 2005 and entitled “Smart Home Control Of Electronic Devices,” which is hereby incorporated by reference in its entirety.

As noted, devices may be associated with various attributes in at least some embodiments, such as is shown in section 245. For instance, an individual device may be associated with its location, whether or not it is a transient device that is in a location or is otherwise available only temporarily, any groups to which the device belongs, and information about presentation capabilities of the device (e.g., the quality of its audio and/or video presentation capabilities). For example, although a TV has speakers, audio functionality for the TV may be given a low rating since the sound may be of a lower quality than a stereo. In some embodiments, various grades of audio and video may be associated with a device. For example, the CM system may track the ability of a television to present Standard Definition Television (“SDTV”), Enhanced Definition Television (“EDTV”), and High Definition Television (“HDTV”), whether the device is designed or configured in a wide-screen or standard size, whether the device is designed to use progressive scan or interlaced, and/or whether or not the device has DRM capabilities. Similarly, the CM system may associate one or more input interfaces (e.g., component video, HDMI, optical audio, S-Video, etc.) with devices so that the CM system may use the most appropriate input to the content presentation device that the content receiver/distributor may allow. Additional details related to device selection are discussed below.

The playlist control area 225 may contain a number of controls and information related to creating and otherwise managing playlists and other content. In particular, in this example the playlist section has various playlist selection tabs 280, a user-selectable list control 275 for selecting a particular playlist or a group of multiple related playlists (e.g., all playlists having a particular type of content or that are associated with one or more particular devices or device groups), a control 260 to initiate definition of a group of one or more playlists (although in some embodiments playlists may not be grouped in such a manner), six controls 295 for controlling how content within the currently selected playlist is presented (such as via “Play”, “Previous”, “Next”, “Clear List”, “Shuffle” and “Loop” controls), other playlist manipulation controls 270 for controlling and manipulating playlists in various ways (e.g., to select devices to present the content on, to create and/or save a new playlist, etc.), a user-selectable control 265 for specifying various content attributes or other criteria to be added to a current playlist, various other playlist content manipulation controls 290 for altering the arrangement and contents in the currently selected playlist (e.g., to move contents items up or down in the current playlist, to remove one or more content items from the current playlist, or to add one or more content items to the current playlist, such as based on a currently selected content piece or item or by interacting with the user to obtain indications of one or more such content pieces or items to be added), and a section 285 that includes various details about a currently selected playlist. In addition, while not currently illustrated, in at least some embodiments in which groups of playlists may be created and used, a playlist group may be selected, and a variety of additional details specific to the playlist group may be displayed (whether instead of or in addition to the playlist details in section 285).

In the illustrated embodiment, playlists may be created in various ways, such as based on a particular type of content and/or for a mixed group of multiple types of content, for a particular user (as manually defined by that user or otherwise automatically generated for that user), for content available from a particular source, etc. In addition, the playlist manipulation controls 270 in this example provide a variety of types of functionality to a user, such as to allow the user to specify one or more devices on which to present the content pieces for a playlist (e.g., by specifying particular devices for particular pieces of content in the playlist; by having a best or otherwise appropriate device present each piece of content, such as when a playlist is directed to a group of devices in a particular location; etc.). In addition, a playlist may be tied to a selected device or group of devices by the user via use of the corresponding control, and the user may also let the CM system suggest or otherwise determine appropriate devices or device groups on which to present the content of a playlist, such as based on content types and device capabilities and device availability (whether at the time of playlist creation and/or later use). In other embodiments, a playlist may be tied to or otherwise associated with one or more device groups and/or devices in other ways, such as by creating a playlist while a particular device or device group is selected. In addition, when a playlist is tied to or otherwise associated with one or more device groups and/or devices, controls may be provided (e.g., in the playlist control area and/or the device control area) in at least some embodiments to transfer a playlist for use on one or more other devices or device groups, whether temporarily (e.g., for a single use) or in a permanent manner (e.g., by adding the one or more other devices or device groups as devices/groups to which the playlist is tied or otherwise associated). While also not illustrated here, playlists may in some embodiments be transferred to other devices and/or users external to a local environment (e.g., via use of appropriate provided controls in the GUI and/or by using communication mechanisms external to the GUI), such as to allow a user to create and distribute playlists to other users for their use. The “Present on Selected Device(s)” may be used to currently present the playlist on one or more selected devices, such as for a selected device group and/or particular selected devices in section 230—in some embodiments a particular playlist may be simultaneously directed to one or more distinct devices and/or device groups for simultaneous presentation (e.g., to present the same content on all speakers or televisions in a home), while in other embodiments different playlists may each be simultaneously directed to different one or more distinct devices and/or device groups for simultaneous presentation. In some embodiments, instead of presenting the entire playlist, small excerpts of the pieces of content may instead be played as a sample, such as to check that the one or more devices are appropriate. The content presentation devices may further be controlled using the “Control Selected Device(s)” user-selectable control, such as by directing a playlist to one or more devices that will control the devices in manners other than by supplying content to be presented, such as by using a playlist to auto-tune a content presentation device or content receiver/distributor device based on the indicated content pieces and/or specified content piece criteria for the playlist. In addition, controls 270 also allow the playlist to be saved and a new playlist to be created.

Content pieces may be selected and manipulated in various manners in various embodiments, such as by clicking on the user-selectable “Add Content Piece” and subsequently selecting a piece of content via an indicated prompt (e.g., by browsing for the content piece via a popup window). Content pieces may also be added to a playlist in various ways in various embodiments, such as by being dragged and dropped onto a playlist, via a menu or other control associated with metadata displayed for the content piece, etc. In addition, when content piece attributes or other criteria are associated with a playlist (whether instead of or in addition to one or more particular pieces of content), the current contents of a playlist may be dynamically populated at various times, such as when the playlist is selected for display in the GUI and/or for presentation on one or more content presentation devices—such criteria may include, for example, one or more of genre, keyword, title, cast/crew, HDTV content, channel, MPAA or TV rating, first run, audio features (e.g., available in other languages, closed captioned, etc.). Similarly, the criteria for a playlist may include an indication of a multi-episode television program or other type of content with multiple distinct associated content pieces, and if so the dynamic population of the playlist may include selecting an appropriate one or more of the multiple associated content pieces (e.g., the latest episode of an indicated multi-episode program). In addition, section 285 shows various details about various pieces of content currently in the playlist. Some details may include a source of the content piece (e.g., one or more content receivers or distributors), the type of the content piece, a description of the content piece, etc. In some embodiments, the type of content may include various additional attributes, such as whether video content is HDTV, a display size for which the video or image content was designed or is appropriate, whether the source is digital or analog, etc. In some embodiments, multiple sources may be available for a piece of content, such as a movie that is available as a previous recorded movie from a cable broadcast and is available directly from a DVD or other source from which the movie can be downloaded or otherwise obtained, and if so only one source may be listed (e.g., the preferred source) or the multiple sources may be listed in order of preference. In addition, as illustrated, a playlist may contain pieces of content from multiple sources and of multiple types. While not illustrated here, in some embodiments a particular piece of content may further have associated parental controls or other access/usage controls, whether specified individually for the piece of content or instead based on the piece of content satisfying criteria specified for such parental controls (e.g., based on attributes of the piece of content, such as an MPAA or TV rating, a violence rating, an associated channel or source, a title, etc.).

Similarly, parental controls and other types of usage/access controls may be specified for playlists in at least some embodiments. When a user-based control such as an access code (e.g., a PIN or password) has been specified as part of a parental control for a playlist, a user who selects that playlist for presentation may be prompted to provide the access code before the playlist is made available for presentation. Similarly, if a parental control or other usage/access control has been specified for a particular piece of content that is part of a playlist, a user making use of the playlist may similarly be prompted for an appropriate access code corresponding to that particular content piece, whether when the playlist is initially selected or when that particular piece of content is to be used. Users may further be prompted to provide various other types of information based on particular types of content that is specified for a playlist. For example, if a particular content piece in a playlist is available as a fee-based on-demand digital media content item, the user may be prompted to verify that the fee should be paid to acquire the content piece (whether when the playlist is initially selected or when the particular content piece is to be accessed), or the user may be prompted for user login or other information if a particular content piece is to be retrieved from an external source that is available only to registered members. Furthermore, such access/usage controls may further in some embodiments be available to further prevent any information about a playlist from being made available to users who lack the appropriate access code, such as to prevent others from viewing the particular content pieces in a playlist, whether a particular playlist is currently available or not (e.g., whether the playlist has expired or is not available at the current time), etc.

As previously noted, a variety of types of criteria may be specified for a playlist (whether instead of or in addition to particular content pieces), and may be used to populate a playlist with one or more pieces of content that match the criteria in various ways. For example, such playlist population may be performed a single time (e.g., at creation or at the time of first use), or may instead be performed multiple times (e.g., each time that the playlist is used). When performing the population of the playlist multiple times, the corresponding group of content pieces for the playlist will typically change to reflect current content at the time of population, although in some situations may select the same group of content pieces multiple times if those same content pieces continue to be the content pieces that match the criteria. In some cases the criteria may be sufficiently general that one or multiple otherwise unrelated television programs will match the criteria (e.g., any content of an indicated genre that has a rating above a specified threshold), while in other cases the criteria may be more specific (e.g., an indication of a television program series or other group of multiple associated content pieces). When the criteria for a playlist indicates, for example, a weekly television program series, populating the playlist on different weeks may result in a different episode of the series being selected (e.g., the most recently shown episode, or the most recent non-rerun episode).

In some embodiments, a group of content pieces selected to populate a playlist having specified criteria may be used only until the playlist is again re-populated, but in other embodiments other types of behavior may be provided (whether for all playlists, for selected playlists in a manner configured by users who create the playlists, and/or for selected playlists in a manner configured by users who are using or otherwise managing the playlists, such as users distinct from the creating users). For example, in some embodiments multiple copies or versions of a playlist may be created and maintained, such as to correspond to each time that the playlist is populated (whether in a manner that is initiated by a user or by a change in the content that match the criteria for the playlist). Thus, for example, if the criteria for a playlist indicated a daily television program series (e.g., the nightly news on a particular channel followed by an indicated late-night television program series), a separate version of the playlist may be created for each day for a specified amount of time (e.g., to maintain a week's worth of the prior playlists, or to continue creating new versions indefinitely), with the corresponding content pieces for each of the versions being the episodes or other daily television programs that correspond to the day for the playlist version. In other embodiments, multiple versions of a playlist could be created in manners other than based on time, such as by creating a first version of the playlist with content pieces that are currently available and a second version with content pieces that are not yet available, or by using any other attribute that has multiple values (e.g., to create a playlist whose criteria will select certain types of horror movies, and then to configure that different versions of the playlist will be created to correspond to different quality ratings, thus enabling a “B”-movie playlist version of horror movies with lower quality ratings and a separate “A”-movie playlist version with higher quality movie content pieces).

In some embodiments, content pieces that are associated with one or more playlists may be handled in special manners in various ways. For example, in some embodiments a stored content piece that is associated with a playlist may be retained as long as the playlist is retained, even if those content pieces would have otherwise been deleted (e.g., if by default only one or two episodes of a particular television program series are retained by default, or if stored digital media content items are retained by default for only a limited amount of time). In addition, various types of actions other than storage-related may be taken with respect to content pieces (or “digital media content items”) associated with playlists, such as to associate parental controls with individual content pieces based on parental controls specified for one or more playlists to which those content pieces belong. In addition, such actions may be taken for various types of content pieces, such as content items individually specified for playlists and/or content pieces automatically selected to populate playlists based on matching specified criteria for those playlists.

As noted above, in some embodiments a multi-episode television program series or other recurring type of content item or other group of multiple related content items that is selected for a playlist may result in a playlist (or playlist version) that is populated with a single episode or other single member of a group. In other embodiments, however, a playlist may be used to aggregate multiple such episodes or other group members—for example, a playlist with an indication of a television program series could be populated with all available episodes of that series, such as to allow a marathon viewing of all episodes for an entire season in order. In addition, in some embodiments playlists may be distributed to users for various purposes, such as by a commercial entity for fees charged to users and/or for promotional reasons (e.g., a particular television network might distribute a playlist that includes one or more of the most popular shows on that network as well as one or more other shows for which additional exposure is desired, or a playlist that includes various shows on that network of a particular genre that are broadcast on different days) and/or by other users for fees or instead for free (e.g., as part of an established exchange network for created playlists, such as a network provided as part of the CM system).

Furthermore, in some embodiments the contents of a playlist may include one or more other playlists (referred to as “member” or “child” playlists that are part of a “parent” playlist)—in such a situation, the various content pieces that belong to the children playlists may be directly added to the parent playlist and then treated like any other content pieces in the parent playlist. Alternatively, in at least some embodiments the hierarchical relationship of the playlists may instead be maintained for at least some purposes, such as to allow a user to view the parent playlist's contents in a manner that shows a representation of the children playlists (e.g., in a manner that allows the children playlists to be expanded such that their member content pieces are visible, or instead collapsed so that the member content pieces are not visible). When presenting a playlist that has a child playlist as a member, the individual members of the child playlist may be treated like any other member of the parent playlist (e.g., individually selected and presented when a shuffle mode is in use), or instead the entire child playlist may be selected and treated as a single item (e.g., such that all of the members of the child playlist will always be played together in the order or other manner specified for the child playlist), such as to reflect a configuration choice by the creating user and/or presenting user. While not illustrated here, in some embodiments a user may also be able to define a group of multiple pieces of content together in a manner other than as a playlist (e.g., for simultaneous presentation, such as one or more images with accompanying music), and such content piece groups may be added to a playlist and treated as a content item. Additional details related to playlists are discussed below.

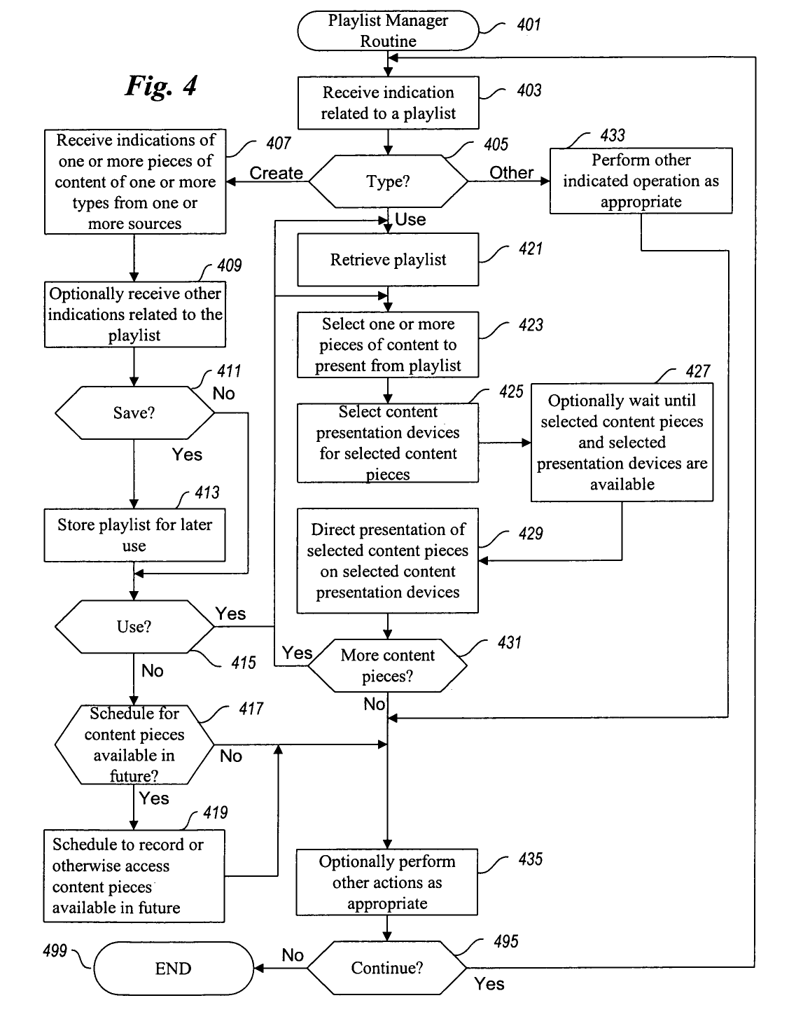

FIG. 4 is a flow diagram of an example embodiment of a Playlist Manager routine 401. The Playlist Manager routine may be provided by, for example, a corresponding playlist manager component (not shown) of the CM system, such as CM system 335 of FIGS. 3A and 3B. The illustrated embodiment of the routine performs various functionality related to managing playlists, including to create and save playlists, to use playlists to control presentation of content on one or more devices, and to use playlists to otherwise control actions of one or more devices.

The illustrated embodiment of the routine begins in step 403, where the routine receives an indication related to a playlist. A request may be of various types, and in step 405 the type of the request is determined. If it is determined to be a request to create a playlist, then the routine proceeds to step 407 where indications of one or more pieces of content of one or more types from one or more sources are received. In some embodiments, these details may also be received in step 403 or performed interactively (e.g., prompting the user to provide the indications, dragging an individual audio track 585 to the current playlist selection section 550 of FIG. 1B). As previously mentioned, in some embodiments, the indications may be one or more pieces of content that are currently available or for content that is to be recorded or watched at some future time. The indications may include content of different types in the same playlist. In addition, in some embodiment, the indications may include criteria for selecting the content that is currently available at the time the playlist is used thus creating a playlist that dynamically selects matching pieces of content. After receiving indications of one or more pieces of content to include in the playlist, the routine in step 409, optionally receives other indications related to the playlist. The indications may include in some embodiments grouping pieces of content such that the group may be reused in other playlists, indicating one or more devices on which to present the pieces of content, indicating one or more devices on which to retrieve the pieces of content, indicating the timing of playback (e.g., indicate that pictures and audio may be simultaneously presented, instead of sequentially displayed), usage or other access controls for the playlist (e.g., parental controls that prevent children from watching content before the child's homework is done), and usage or other access controls for pieces of content within the playlist (e.g. parental controls on pieces of content). After receiving all the optional indications, it is determined whether to save the playlist for later use in step 411. If so, the playlist is saved in step 413 and if not or after saving the playlist, it is determined whether to use the playlist at the current time at step 415. If so, the routine proceeds to step 421. If not, it is determined whether any of the pieces of the playlist are still to be recorded or otherwise scheduled to be available in future (e.g., require download over the Internet) in step 417. If so, in step 419, the pieces are scheduled to be recorded or otherwise scheduled to be available in the future. In some embodiments, the CM system may check to see if there are any conflicts in the scheduling such as checking to see if any content for auto-tuning to live content is set to occur at the same time on the same device. If no content pieces needed scheduling or after scheduling the pieces of content to be available, the routine continues to step 435.

If in step 405 the routine determines that the indications related to a playlist are to use the playlist, the routine retrieves the playlist in step 421. Although not shown, in some embodiments, the routine may check to see if use of the playlist is authorized such as requiring a user to login or by enforcing access/usage restrictions specified in step 409 when creating the playlist. After retrieving the playlist, the routine selects one or more pieces of content to present from the playlist in step 423. In some cases, only some of the content may be selected because one or more pieces of content may not be currently available (e.g., the DVR that recorded the program may be busy or not working, content may not have finished downloading from the Internet, one or more pieces of content may be stored on a portable device that is no longer reachable by the CM system). In other instances, content may be dynamically selected based on criteria previously specified by the user such as in step 409. In some embodiments, the routine may also select the one or more pieces of content based at least in part on the timing indications; thus, the routine may select two pieces of content that was designated to be played simultaneously (e.g., one or more images and an audio track. After selecting the one or more pieces of content, the content presentation devices used to present the one or more pieces of content are selected in step 425. The CM system may automatically determine the most appropriate device to present the content (e.g., based on factors such as the relative quality of audio, type of content (HDTV output to a television capable of displaying it), etc.) while in other embodiments the CM system may determine the content presentation devices by using the device or group of devices that the users specified when creating the playlist, using one or more devices indicated in step 403 (e.g., a pop-up was presented asking for one or more devices to present the content on), presenting the content on the nearest content presentation device to the user capable of presenting the content. After selecting one or more devices for the selected pieces of content, the routine proceeds to step 427.

In step 427, the routine may need to wait for pieces of content or devices to be available. In some cases, devices may not be available because the device is not turned on while in other embodiments the CM system may be able to turn the device on. Nonetheless, a device may still not be available because the device may currently be in use or a portable device not in the location expected (e.g., the laptop used as a content-presentation device may not be at home). One or more pieces of content may not be available as the content has not been recorded yet, downloaded yet, currently being presented on another device, or the time to auto-tune to live content has not occurred. After optionally waiting for the pieces of content or for the content presentation devices to become available in step 427, the routine proceeds to step 429. At step 429, the routine directs presentation of the selected content pieces on the selected content presentation devices. As previously discussed, the routine may direct the presentation directly or via one or more intermediary devices (e.g., one or more STBs or media centers). After presenting the content, the routine determines whether there are more pieces of content in the playlist in step 431. If there are more pieces of content in the playlist, the routine returns to step 423 and if there are no more pieces of content, the routine proceeds to step 435.

If the routine in 405 determines that the type of request is not to create a playlist or use a playlist, the routine performs other operations as appropriate in step 433. In some embodiments, the other operations may include, but are not limited to, displaying a list of playlists, managing/modifying previously saved playlists, or transferring one or more playlists to another device for backup or use via a GUI on the other device (e.g., transfer the playlist so it can be used on the Web GUI or the mobile GUI). After performing the additional processing, the routine proceeds to step 435.

In step 435, the routine optionally performs additional processing such as housekeeping or logging out of a user. Once the routine optionally performs additional processing in step 435, the routine determines whether to continue at 495. If so, the routine returns to step 403 and if not, the routines ends as step 499.

In some embodiments, at least some playlists may be created automatically such as the most popular programs or all the programs meeting some predetermined criteria (e.g., program that are appropriate for children based on the MPAA or TV ratings, all prime time shows airing on a certain night, etc.).

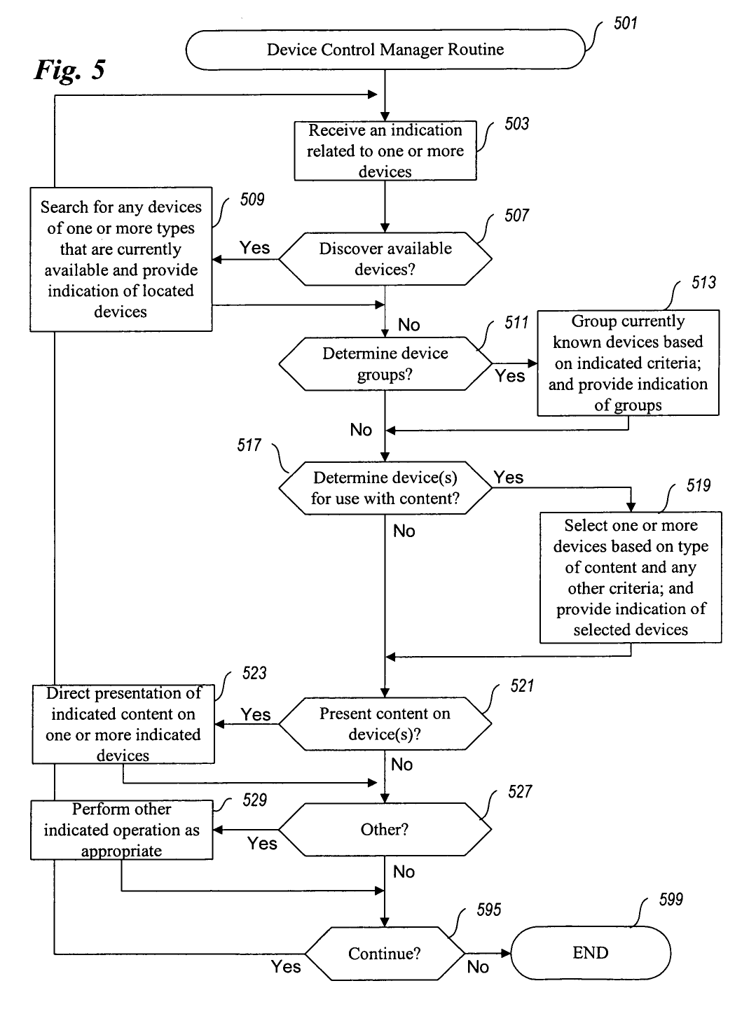

FIG. 5 is a flow diagram of an example embodiment of a Device Control Manager routine 501. The Device Control Manager routine may be provided by, for example, a corresponding device control manager component (not shown) of the CM system, such as CM system 335 of FIGS. 3A and 3B. The illustrated embodiment of the routine performs various functionality related to managing devices and device groups, including to discover available devices, determine device groups, determine devices to use to present one or more types of content, and to direct content for presentation to one or more devices.

The illustrated embodiment of the routine begins in step 503, where the routine receives an indication related to one or more devices. In later steps, the routine determines that the type of the request. For example, in step 507, the routine determines whether the request was to discover available devices. If so, the routine searches for any devices of one or more types that are currently available and provides indication of located devices. In some embodiments, a request to search for one or more devices may be trigged by a user request (e.g., by clicking on the “Refresh Devices” or “Device Search” buttons of FIG. 2) while in other embodiments devices may be searched on a scheduled basis. In some embodiments, step 507 may only search for devices of a particular type (e.g., a user indicated type of content-presentation device or for transient devices that may change location). Devices may unavailable based on whether the content-presentation device is in use (or about to be used in the near future), whether the device is currently off and there is no ability of the CM system to turn the device on, and whether or not any access controls in effect allow access to the device for the current user. If the request was not to determine available devices or after available devices have been determined the routine proceeds to step 511.

At step 511, the routine determines if the request was to determine device groups. If so, at step 513, one or more devices are grouped together based on indicated criteria and the routine then provides indications of the group. Criteria to group devices may include grouping all or some of the content presentation devices in one location, grouping all the temporary content-presentation devices, grouping content-presentation devices to a content receiver/distributor, all or some of the devices of a particular content type (e.g., to be able to play different audio to assist in creating theme rooms for a party, tune all televisions to the Super Bowl for a Super Bowl party, etc.). Devices may also be grouped by their grades such as all the HDTV-capable televisions. In some embodiments, at least some device groups may be automatically created and at least some device groups may be associated with a particular user of the CM system. The indications of the group may result in the GUI been updated to include an additional tab and/or selection in the drop down list If the indicated request was not to group devices or after grouping devices, the routine proceeds to step 517 to determine one or more devices to use to present content. If the request was to determine one or more devices to use to present content, then in step 519, the routine determines one or more devices based on the type of content and any other criteria and provide indications of selected devices. Devices to use to present content may be based on the attributes known about a device (e.g., relative quality of audio and/or video, the grade of the device), currently available devices, and a group of devices that can play all the pieces of content. In some embodiments, the users may manually choose the device. If the indications were not to determine devices to present the content on or after determining one or more devices to present the content on, the routine proceeds to step 521.

At step 521, the routine determines if the indications were to present content on one or more devices. If so, in step 523, the routine directs presentations of indicated content on one or more indicated devices. The indicated devices may have been indicated in 503 or indicated by being selected in step 519. In some embodiments, one or more devices may have been indicated as part of creating a playlist containing the content that is currently being displayed. As previously discussed, the routine may direct the presentation by directly interacting with the content presentation device or via interacting with one or more intermediary devices. After presenting the one or more pieces of content on the one or more devices or if the indications were not to present the one or more pieces of content, the routine proceeds to step 527.

In step 527, the routine determines if the indication was to perform other operations. If so, the routine performs other indicated operation as appropriate in step 529. Other operations may include manually registering a device with the system, providing additional information about the capabilities of a device if the capabilities cannot be automatically discovered, and specifying device or group access controls such as parental controls. After performing the indicated other operation or if the indication was not to perform other operations, the routine proceeds to step 595 where the routine determines whether to continue. If so, the routine returns to step 503 and if not, the routine ends at 599.

The Device Manager routine 501 may be performed in various ways in various embodiments. For example, the Device Manager routine may similarly perform some or all of its functionality for content receivers/distributors in addition to content presentation devices.

As previously noted, FIGS. 6A-6S provide examples of a mobile GUI and related capabilities that may be used in some embodiments with a cellphone or other mobile device, such as a device with a limited display screen and/or limited input device capabilities (e.g., a device without an alphanumeric keyboard). As discussed in greater detail below, in at least some embodiments all of the various GUI capabilities discussed elsewhere with respect to a PC-based GUI may similarly be provided as part of this mobile GUI on the cellphone or other device (whether in the same or different manners from those capabilities, while in other embodiments only a subset of the capabilities may be available (e.g., to limit at least some displays of information to only a single size or level of detail, such as due to limited available display area).

In particular, FIG. 6A illustrates an embodiment of a smartphone cellphone device 600 that includes a display area 605 and various controls, although in other embodiments a corresponding device may have other controls and/or a different form factor. In the illustrated embodiment, the cellphone includes various user-selectable numeric controls 610, various controls 615 to control voice-based communications and to allow selection and other movement through a displayed list of items or other menu (not shown), various controls 617 to alter content presentation (e.g., to control volume), various controls 616 to correspond to dynamically modifiable controls displayed to the user (not shown), and an area 619 to indicate when recording is to occur and/or is occurring and to optionally in some embodiments allow user control of such recording.

FIG. 6B illustrates various information in the display area of the cellphone, which in this example includes a current status area 630, a current selection area 625, and one or more user-selectable controls 620—in the illustrated embodiment, each of the user-selectable controls 620 may be selected by activation of a corresponding hardware control on the cellphone immediately below the control 620, although in other embodiments such controls may be activated in other manners (e.g., by direct selection if the display area is touch-sensitive). In the illustrated embodiment, the current selection area illustrates a menu of 9 options that are selectable by the user to obtain various types of functionality and content, and the current status area includes a title for software that is executing on the cellphone to provide the illustrated capabilities (which in this example is “Mobile Ambient”) and information about a current status of the cellphone's battery and connection signal strength. In this example embodiment, the functionality and content correspond to television programming, although in other embodiments various other types of content may be controlled.

After selection by the user of the first “Search for Shows” option in the current selection area 625 (such as via controls 615 and/or 610), the display area of the cellphone changes to show search information 632, as shown in FIG. 6C. The current status area is also modified to indicate that “Search for Shows” functionality is being provided, and the battery status indication may be replaced with various other information (e.g., an indication of a currently selected channel). In the illustrated embodiment, the search information includes a user-specifiable text input field 632a in which the user can specify one or more keywords to use in the search (e.g., using the numeric controls 610, or using a virtual keyboard displayed in the display area, not shown), as well as a list of genre from which the user can select. Various other types of search options can additionally be specified in other embodiments. In addition, the controls 620 are modified so that the user can initiate a search by using the “Search” control, or can use the “Menu” control to return to the options menu displayed in FIG. 6B (whether due to the “Menu” control always returning to that options menu regardless of the menu level, or due to the control causing the next-higher display level to be shown). FIG. 6D shows additional information in the search information 632 area, such as due to the visual display being scrolled down by the user (e.g., via controls 615 and/or 617), which in this example includes a list of sorting options that the user can select for the search results. After the user performs a search, the results of the search will be displayed to the user (not shown), such as in a user-selectable list format from which the user can select a television show to be manipulated (e.g., as to be recorded and/or to be presented on the cellphone or on a television device being controlled).

If the user instead selects the second option “Browse Channels” in the current selection area 625 of FIG. 6B, the display area of the cellphone changes to show channel-related information 635, as shown in FIGS. 6E and 6F. The current status area is also modified to indicate that “Channel View” functionality is being provided in FIG. 6E, and the controls 620 are modified in FIG. 6E to allow the user to specify a television program to be presented via the “Watch” control (e.g., a television program from a currently selected channel, although in the current example no television programs are currently illustrated). In this example, the user can select a displayed option to list the available channels, and the information 635 of FIG. 6F illustrates an example of a listing of channels that may result from such a selection (or instead by default after selection of the “Browse Channels” option from FIG. 6B). As is shown, the user has currently selected the “KONG (6)” option 635a from the list of channels, and subsequent selection of the “Done” control 620 may cause information to be listed for that channel (e.g., to show programs to be shown on that channel at various times, such as in a list) or may cause the current program on that channel to be selected for current presentation. FIG. 6G illustrates example information 635 that corresponds to a list of programs on the currently selected “KONG (6)” channel, with the first television program “Judge Hatchett” 635b currently selected (e.g., due to that program being the current program being displayed and/or the next program to be displayed). In this example, the user is also provided with a control 620 to “Record” the currently selected program. After the user scrolls down, FIG. 6H illustrates additional programs, as well as option 9 to see more programs for the channel (e.g., such as based on selection of the “More” control 620 and/or the “9” numeric control 610).

If the user instead selects the third option “Browse Date/Time” in the current selection area 625 of FIG. 6B, the display area of the cellphone changes to show information 640 to allow a date and time to be specified by the user, as shown in FIG. 6I. The current status area is also modified to indicate that “Select Date/Time” functionality is being provided, and the controls 620 are modified to allow the user to indicate that they are “Done” or to cancel the date/time selection. In this example, the user can select a displayed option 640a to list and select a day, and may similarly list and select a time on that day. FIG. 6J shows the results for a selected date and time (in this example “Thursday March 24” at “8:30 pm”), with a list 645 displayed of programs that are being presented at that day and time. The current status area is also modified to indicate that the “Date/Time View” view is being provided, and the controls 620 are modified to allow the user to indicate to “Record” a currently selected program such as the “Northwest News Today” program 645a on channel 2. Various additional details related to displaying information about television programs at selected times are described previously, and in some embodiments some or all of those capabilities may similarly be provided here.

As previously noted, a particular television program may be selected in various ways, such as by searching for shows, browsing channels, and browse at a specified date and time. FIG. 6K illustrates example program information 650 that may be displayed for a particular program that is selected by the user, with the current status area modified to indicate that “Program Info” functionality is being provided, and the controls 620 are modified to allow the user to indicate that they are “Done” or to indicate that one or one or more additional actions may be taken with regard to the current program (e.g., to record the program, cause the program to be currently presented on the cellphone or a specified other output device, etc.). In addition, in this example the program information includes additional user-selectable controls, such as for the user to select control “Sinbad” 650a to obtain additional information about the actor “Sinbad” (e.g., biographical information, information about other programs with which Sinbad is associated, etc.). FIG. 6L then displays a control menu 655 that may be displayed to the user to allow the user to take additional action with respect to the currently selected program 655a (e.g., in response to selection of the “Actions” control 620 in FIG. 6K), such as to record this showing, record multiple programs from this series, cancel a previously scheduled recording, play an existing recording, erase an existing recording, etc.

If the user instead selects the fourth option “Scheduled Recording” in the current selection area 625 of FIG. 6B, the display area of the cellphone changes to show information 660 regarding scheduled programs, as shown in FIG. 6M. The current status area is also modified to indicate that “Scheduled Recordings” functionality is being provided, and the controls 620 are modified to allow the user to indicate to “Remove” a scheduled recording, such as currently selected scheduled recording 660a. Alternatively, if the user instead selects the fifth option “Recorded Programs” in the current selection area 625 of FIG. 6B, the display area of the cellphone changes to show information 665 regarding previously recorded programs, as shown in FIG. 6N. The current status area is also modified to indicate that “Recorded Programs” functionality is being provided, and the controls 620 are modified to allow the user to indicate to “Play” a program, such as currently selected recorded program 665a. Various additional details related to recording programs and manipulating recorded programs are described previously, and in some embodiments some or all of those capabilities may similarly be provided here.

If the user instead selects the sixth option “DVR Remote Control” or the seventh option “TV Remote Control” in the current selection area 625 of FIG. 6B, the display area of the cellphone changes to show information 670 of FIG. 6O or information 675 of FIG. 6P, respectively, and the current status areas and controls 620 are modified accordingly. The information 670 of FIG. 6O allows the user to specify various controls 672 to control an indicated DVR 673 (e.g., that is presenting content on an associated television device), and further provides information 674 regarding current content being presented by the DVR. Similarly, the information 675 of FIG. 6P allows the user to specify various controls to control a television device in a manner akin to a remote control, such as based on instructions 677 displayed to the user to use corresponding phone controls.

If the user instead selects the eighth option “Control Options” in the current selection area 625 of FIG. 6B, the display area of the cellphone changes to show information 680 of FIG. 6Q to show a list of options. If the user selects the first option “Active Devices”, corresponding functionality is provided to the user to select one or more active devices being controlled or for which information is presented when using other options, as illustrated in FIG. 6R. If the user selects the second option “Options”, corresponding functionality is provided to the user to select one or more of various other types of options, as illustrated in information 685 of FIG. 6S.

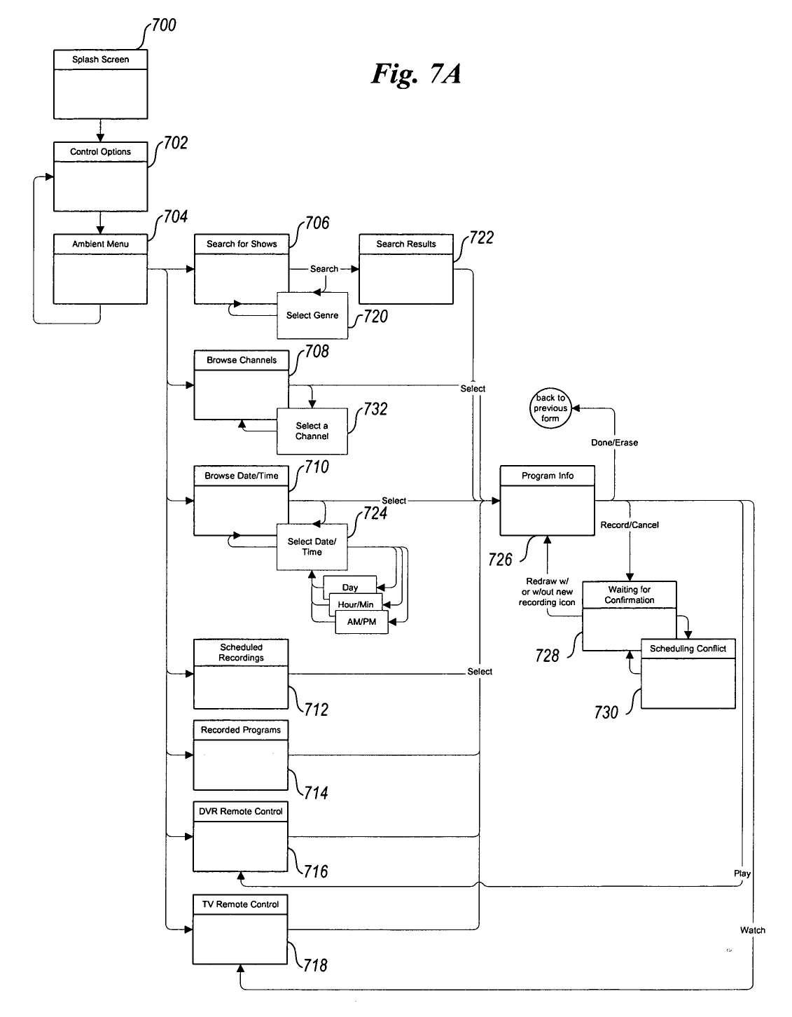

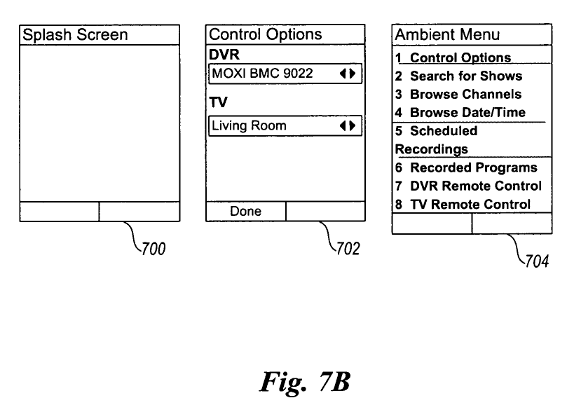

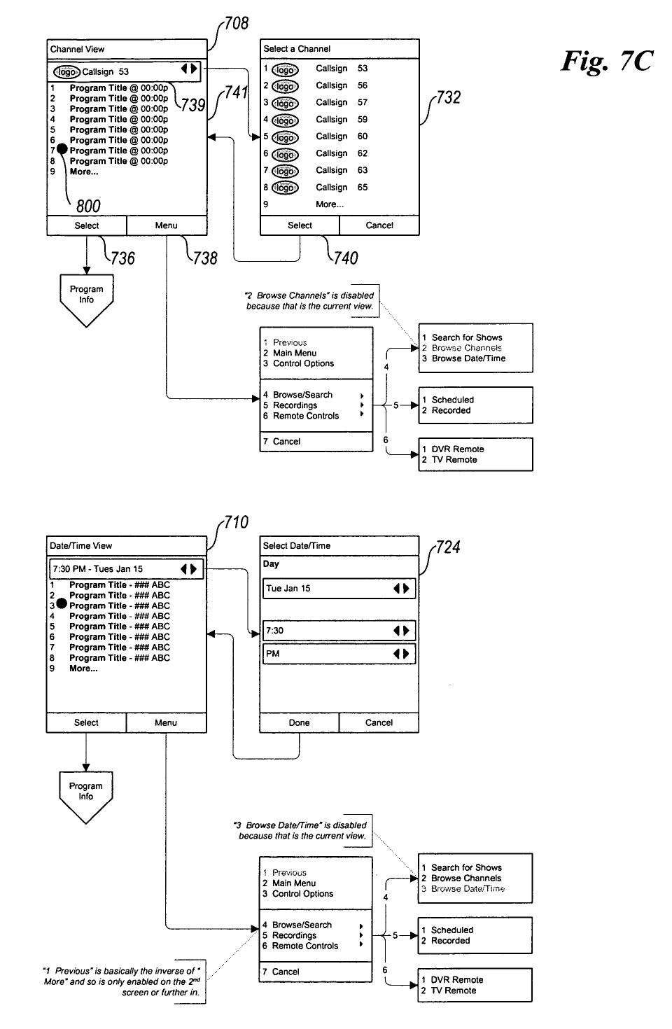

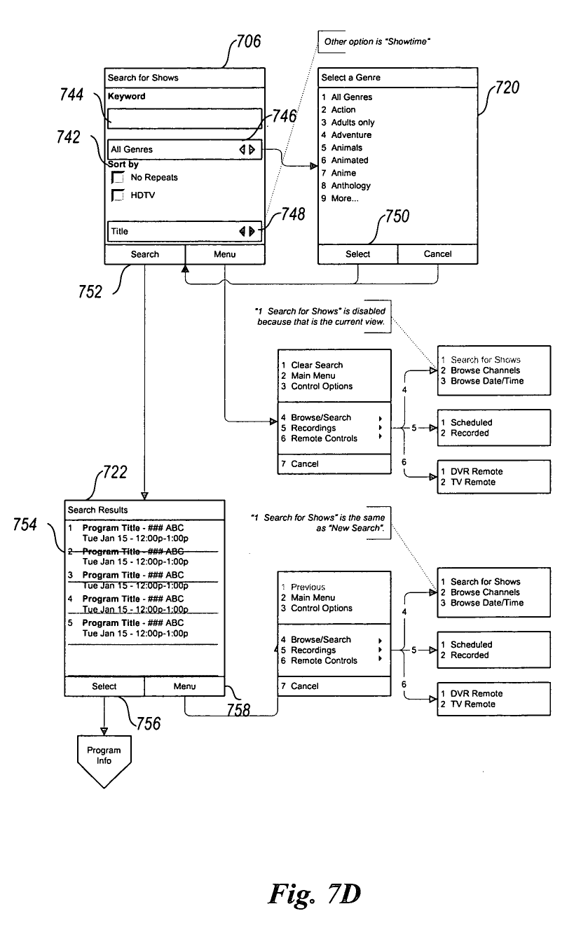

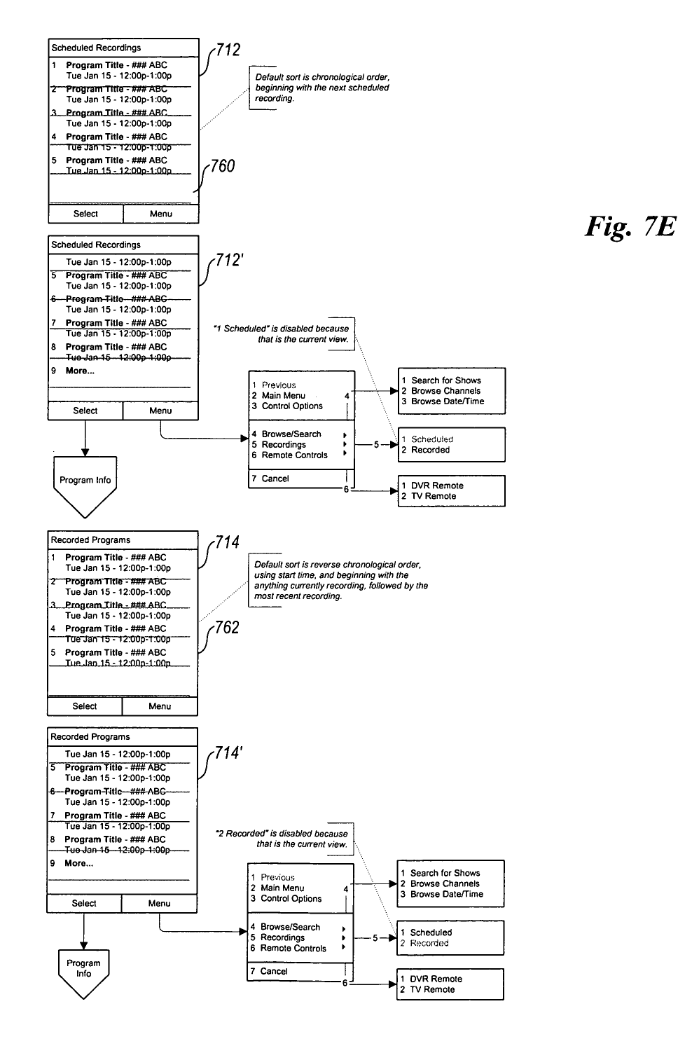

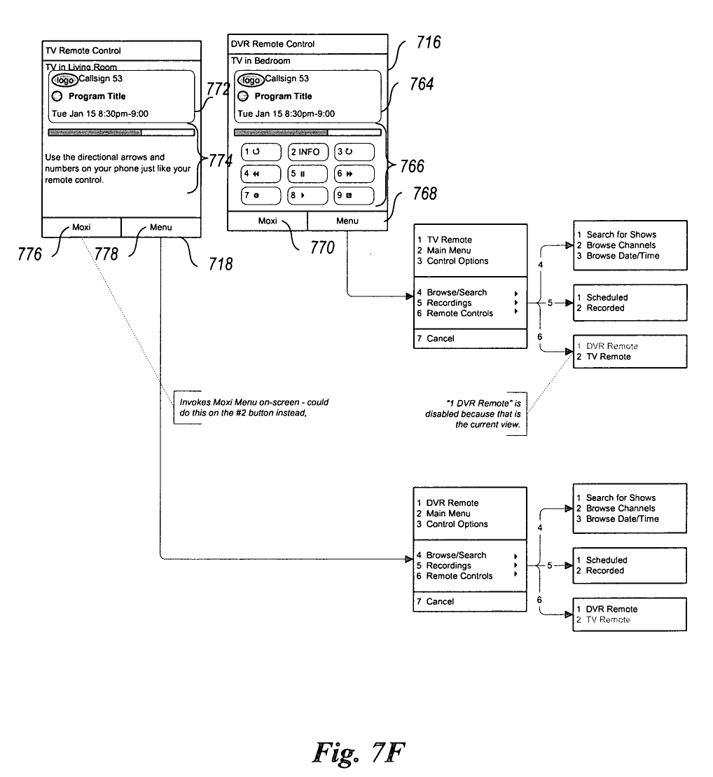

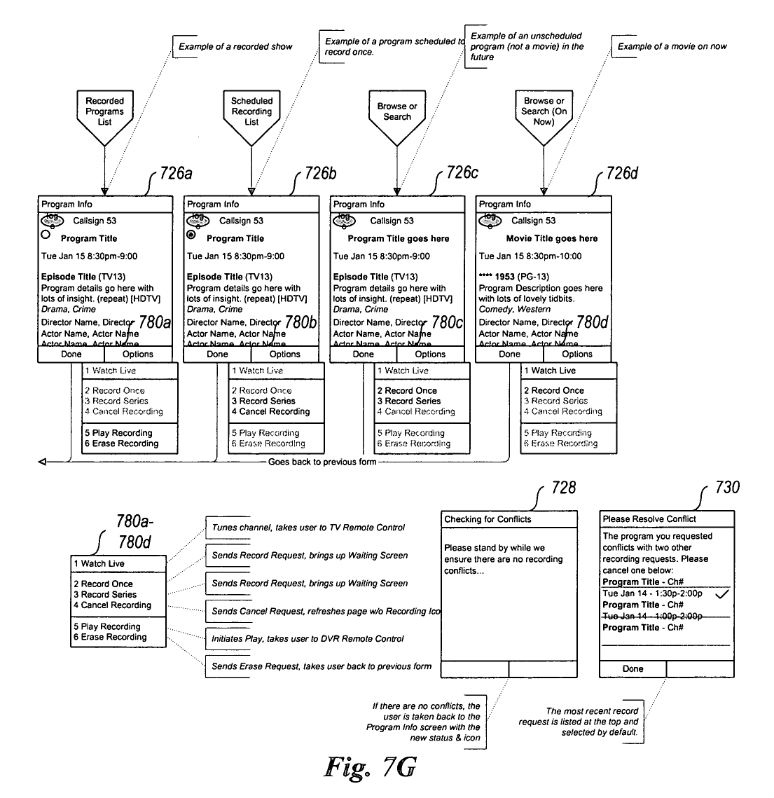

FIGS. 7A-7G are various diagrammatic representations of embodiments of screen flows and/or screen contents corresponding to the embodiments of FIGS. 6A-6S, such as for a cellphone or other mobile device. The various screen flows and screen contents are intended to be illustrative and are not intended to be limited to any particular order of screen presentation and/or particular contents (e.g., screen options, menus, listings, and other information) of the screens.

In FIG. 7A, the user is presented with a splash screen or other introductory screen 700 on the display area 605. At a screen 702, the user is presented with control options, and from the screen 702, the user can select to view a screen 704, such as the example shown in FIG. 6B, to access a menu.

From the screen 704, the user can select various options (such as those illustrated in FIG. 6B). Selection of any particular option from the screen 704, results in presentation of a corresponding one of screens 706-718. For example, if the user selects the “Search for Shows” option from the screen 704, then the screen 706 is presented. From the screen 706, the user can specify search criteria (such as a genre) via one or more fields, screens, menus, or other input 720. After the search is performed, the results are presented in a screen 722.

As another example, the user can access the screen 710 to perform a search based on date and time input 724. A screen 726 presents program information corresponding to a user-selected program being televised at a specific date and time, such as the example embodiment shown in FIG. 6K. From the screen 728, the user can record, cancel recording, erase recording, instruct a DVR to play back a recorded program (via the screen 716), tune to and watch a program (via the screen 718), or perform other operation. Screens 728 and 730 can be provided to confirm recording status and to address scheduling conflicts, respectively.

FIG. 7B shows the examples of contents of the screens 702 and 704 in greater detail. For instance, the screen 702 can allow the user to access controls and submenus for various devices being controlled, such as a particular one of a plurality of DVRs, a TV (or STB) at different locations in the home, and so forth. The screen 704 shows listings of submenus that can be accessed (e.g., the menus 706-718 of FIG. 7A).

If the user selects from the Browse Channels option from the screen 704, the screen 708 is rendered. Example contents of the screen 708 of an embodiment is illustrated in further detail in FIG. 7C in channel view format. In FIG. 7C, the screen 708 includes a channel option 734, a select option 736, and a menu option 738. A display area 741 of the screen 708 lists the programs and times on the current channel (e.g., channel 53 in the illustrated example), with a currently selected program being indicated by an indicator 800. Similar indicators can be provided in any of the other screens described and shown herein.

If the user selects the channel option 734, a screen 732 is rendered, which lists various channels that the user can select to obtain additional information for programs being broadcast on the selected channel. After navigating to any of the selected programs, a select option 740 on the screen 732 can be used to select that program to view information (e.g., program titles and broadcast times) on the display area 741.

The select option 736 can be used to access the program information screen 726 of FIG. 7A. The menu option 738 can be used to access any of the options and submenus that are available from the screens 702 and 704, or to access any other menu.

FIG. 7C also illustrates examples of the screen 710 (for selecting or viewing program listings) according to day/time view format. Further details of the screen 724 are also shown, where the user can select or enter particular days and times to search for and display program listings. Analogous to the features of the screen 708 described above, the contents of an embodiment of the screen 710 also include a display area that presents program titles and other information, a select option, and a menu to return to a previous menus (if the menus are arranged hierarchically) or to access any other menu(s). Options pertaining to the current view are disabled.

FIG. 7D show features and/or contents of an embodiment of the screen 706 in greater detail, via a search for shows format. The screen 706 includes various features to allow a user to provide or select search criteria. For example, a field 740 allows the user to search based on keyword. A feature 748 allows the user to access a menu or listing of selectable program titles. A feature 742 allows the user to perform sorting or other filtering, such as specifying that repeat programs not be included in the search results.

A feature 746, if selected in one embodiment, results in presentation of the screen 720. The example screen 720 of FIG. 7D lists various example genres that can be selected by a user by navigating to a desired genre and using a select option 750 to select the desired genre. Thereafter, the selected genre is indicated in the screen 706 as search criteria at the feature 746.

The user can initiate a search by activating a search option 752 (which can be embodied as one or more of the controls 620 shown in FIGS. 6C-6S). Activating the search option 752 results in presentation of the screen 722 that shows search results. Example contents of the screen 722 are also shown in FIG. 7D.

The screen 722 of an embodiment includes a display area 756 that presents the search results, such as program title, channel, date, time, etc. Also, an embodiment of the screen 722 can include a select option 756, which if selected by the user, causes the display area 756 to present additional information and/or various options (e.g., recording, watching, etc.) related to the selected program, such as previously described above. A menu option 758 can also be provided to allow the user to access any previous menu in the hierarchy and/or to access any other menu or option. Options pertaining to the current view are disabled.

FIG. 7E shows example contents of an embodiment of the screen 712 in greater detail, such as program title, channel, date, and time of programs that the user has scheduled for recording. Such contents can be presented on a display area 760 of the screen 712, and the information therein can be listed chronologically beginning with the next scheduled recording, alphabetically, by genre, or based on some other criteria or combination thereof.

A screen 712′ illustrates that the user can organize according to, and/or the screen 712 can list, programs that are scheduled for broadcast on a specific day and time slot. The screen 712 and/or 712′, as with the screens previously described above, can include select and menu options. Options pertaining to the current view are disabled.

FIG. 7E also illustrates example contents of an embodiment of the screen 714, such as program title, channel, date, and time of programs that the user has recorded, using a DVR or other suitable recording device. An embodiment of the screen 714 includes a display area 762 that presents listings of recorded programs or other recorded content.

A screen 714′ illustrates that the user can organize according to, and/or the screen 714 can list, recorded programs that were broadcasted on a specific day and time slot. The screen 714 and/or 714′, as with the screens previously described above, can include select and menu options. Options pertaining to the current view are disabled.

FIG. 7F illustrates example contents and features of embodiments of the screens 716 and 718 in more detail. In particular, FIG. 7F shows contents and features of the screen 716 for controlling a DVR and the screen 718 for controlling a television, both in a manner akin to a remote control, such as shown and described above with respect to FIGS. 6O and 6P.

With respect to the screen 716, a display area 764 presents program information, such as channel, title, and day and time. Other information 766 can be presented on the screen to represent DVR controls and/or DVR-related indicators.

A menu option 768, if selected, causes menus, submenus, and/or other selections to be presented to the user, so that the user can navigate to a different menu in the hierarchy and/or perform any other operation. Options pertaining to the current view are disabled.

Other options 770 can be provided. An example is a MOXI menu or other menu/feature that can be invoked by selecting the options 770. Alternatively or additionally, the MOXI menu or other menu can be invoked by selecting one of the buttons represented by the other information 766.

With respect to the screen 718, a display area 772 can be provided to present television program-related information. Other information 774 can also be presented in the screen 718 to represent indicators or a keypad (for example) that simulates a TV remote control. Alternatively or additionally, instructions can be rendered that instruct the user to use numeric and other buttons of the cellphone to perform entry and selection. Other options 776 and 778 can be provided with the screen 718, analogous to the options 770 and 768 described above with respect to the screen 716.

FIG. 7G illustrate example contents and features of an embodiment of the screen 726 in greater detail. More specifically, FIG. 7G illustrates various example program information and related features in more detail. For example, screens 726a-726d show example details respectively for: recorded programs, scheduled recordings; browsed or searched programs; browsed or searched programs that are currently showing, just to name a few examples.

For any of the screens 726a-726d, information can be presented, such as channel (and channel logo), program title, day and time, episode title, program details, genre, names of actors and directors, and so forth. Moreover, any of the screens 726a-726d can further include options 780a-780d, respectively, which allow the user to access one or more screens or submenus that contain features pertaining to the particular respective screen. For instance, selecting the option 780a for the screen 726a can result in a submenu to be presented. As shown by example in FIG. 7G, the submenu includes choices that are relevant to recorded programs, such as play recording or erase recording, while non-applicable choices are disabled. Corresponding applicable enabled and disabled choices can be similarly presented for the screens 726b-726d.

Examples of the various choices that are available through these submenus are watch live TV (tunes channel and takes user to TV remote control screen), record once (sends a record request and brings up waiting screen), record series (sends a record request and brings up waiting screen), cancel recording (sends cancel request and refreshes page without presenting a recording icon or other indicator), play recording (initiates playback and takes the user to a DVR remote control screen), and erase recording (sends erase request and takes the user back to a previous form or screen). Other choices and features/functionality may be available in other embodiments.

FIG. 7G further illustrate example contents of the screens 728 and 730. Specifically, the screen 728 alerts the user that the system is verifying whether or not there are conflicts in the programs that the user has scheduled for recording. If there are no conflicts, an embodiment takes the user back to a program information screen 726 with new status information and updated recording icons (or other indicators).

If there are conflicts, then the screen 730 is presented. The screen 730 of the example of FIG. 7G lists various programs where there are scheduling conflicts (e.g., two programs to be recorded in overlapping time slots), with the most recent record request listed at the top and selected by default, for example. The scheduled recording that is causing the conflict may be identified with a check mark, bold face, different highlighting color, or other suitable identification technique. For DVR systems that do not permit recording of overlapping programs, an embodiment of the screen 730 requests the user to resolve the conflict, such as by selecting not to schedule recording of one of the programs or by taking some other action to remove the conflict.

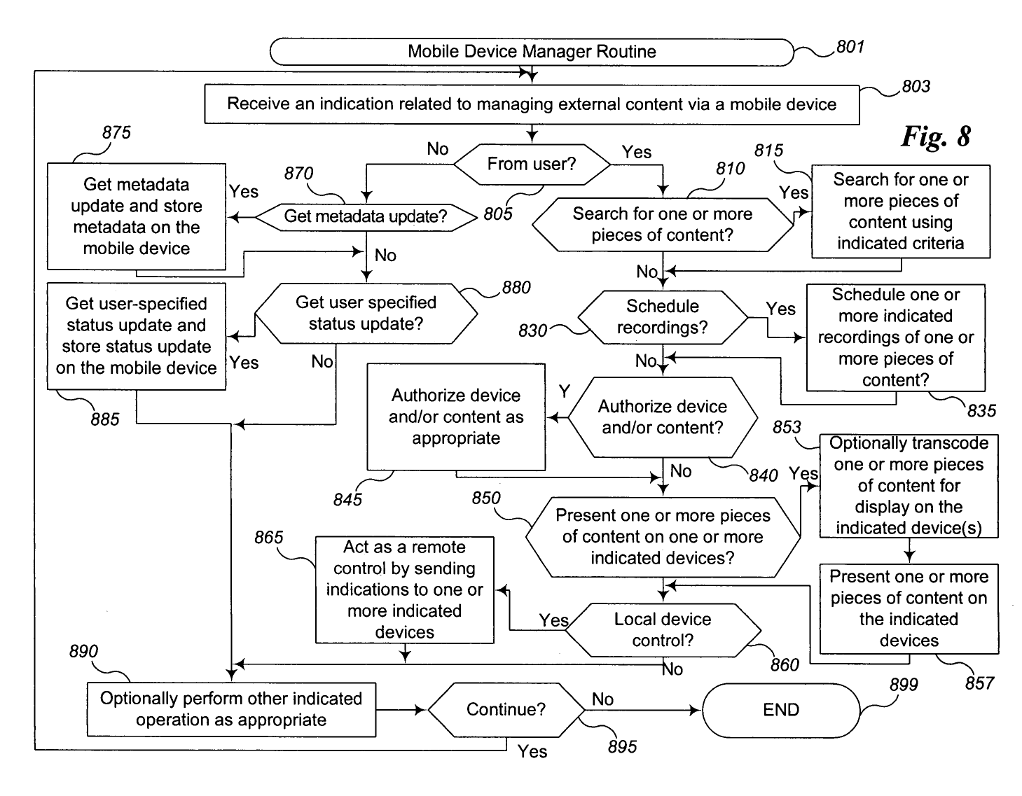

FIG. 8 is a flow diagram of an example embodiment of the Mobile Device Manager routine 801. The routine may be provided by, for example, execution of the CM application 422 of FIG. 3B and/or the Web-based GUI made available using the browser 420 of FIG. 3B, such as to interact with a user of a mobile device so as to provide management of various types of external content via the mobile device. In some cases, the mobile device may maintain various local state information in various ways, including by locally storing and maintaining state information for remote devices and about viewing state information for a separate PC-based GUI of the CM system, and information on the mobile device may be personalized to the device and/or the user of the device in various ways.

The illustrated embodiment of the routine begins in step 803, where the routine receives an indication related to managing external content via a mobile device. The indication may indicate the action to perform and any information related to the indicated action. After receiving the indication, the routine determines if the indication was from a user in step 805. If so, the routine proceeds to step 810. At step 810, the routine determines if the indications were to search for one or more pieces of content. If so, the routine searches for one or more pieces of content using indicated criteria. The indicated criteria may have indicated in step 803 while in other embodiments the criteria may be indicated during step 815. The search may be populated using program detail information from either the CM computing system or local metadata. If the search was performed locally, the search may be saved and later synchronized with the CM computing system. In some embodiments, a search may differentiate between different types of content. For example, a user may confine the search to live programs or previously recorded programs. Similarly, a user may limit the search to content that is locally available to the mobile device such as pieces of content that may be streamed or downloaded to the mobile device.

After searching for one or more pieces of content or if the indicated operation was not to search for one or more pieces of content, the routine proceeds to step 830 where it is determined if the indicated operation is to schedule a recording. If so, the routine schedules one or more indicated recordings of one or more pieces of content in step 835. The content may be scheduling for recording by interacting with the CM computing system; while in other embodiments content may be scheduled for recording by interacting directly with the device that will be recording the content or interacting directly with one or more intermediary devices. In some embodiments, the mobile device may also schedule downloads of one or more pieces of content in addition to scheduling recordings.

After scheduling the recording of content or if the indicated operation was not to schedule recordings, the routine determines if the indicated operation is to authorize a device and/or content in step 840. If so, the routine authorizes the device or content as appropriate in step 845. Authorization may be required if access or usage controls prevent a current user from currently using the device such as a parent preventing a child from using the main stereo when they are away for the weekend or the parent authorizing a particular use of a content presentation device while the child is otherwise grounded and not allowed to use any content presentation devices. In addition, a parent may also remotely authorize content that would otherwise be unpresentable based on previously specified parental controls. Roommates may also remotely authorize the use of their personal content presentation devices remotely. In addition, previously specified time controls may be also be modified remotely using the mobile device in some embodiments. After authorizing the device and/or content as appropriate or if the indicated operation was not to authorize the device and/or content, the routine proceeds to step 850.

In step 850, the routine determines if the indicated operation was to present one or more pieces of content on one or more indicated devices. If so, in step 853, the routine optionally sends indications to transcode one or more pieces of content for display on the indicated devices. Depending on the type of content and the content presentation device, the one or more pieces of content may be transformed for optimal presentation on the indicated content presentation device. For example, television shows recorded on a DVR may need to be transcoded for display on the mobile device. Similarly, video recorded on a mobile device may need to be upconverted for presentation on a television. After optionally transcoding the one or more pieces of content, the routine presents one or more pieces of content on the indicated devices in step 857. After presenting the one or more pieces of content or if the indicated operation was not to present one or more pieces of content, the routine proceeds to step 860.

In step 860, the routine determines whether the indication was for local device control. If so, the routine proceeds to step 865 where the mobile device acts as a remote control by sending indications to one or more indicated devices. In some embodiments, the indications are sent directly to the device being controlled but in other embodiments the indications may be sent via the CM system. The remote may communicate with the indicated devices using various protocols including infrared, Bluetooth, IEEE 1394, wireless IEEE 1394, Z-wave or HAVI. While acting as a remote control, the mobile device may be present a user interface specific to the type of device it is controlling (e.g., the mobile device may not have channel up/down controls for a stereo). If the indications were not for local device control or after controlling the local device, the routine proceeds to step 890.

If in 805, the routine determines that the indications were not from a user, the routine in step 870 determines that whether the indication was to get a metadata update. Metadata may include program schedules and information about the various pieces of content that are available on any of the content receivers/distributors. If so, in 875, the mobile device gets the metadata update and stores the metadata on the mobile device. After storing the metadata or if the indication was not for a metadata update, the routine then determines if the indication was to get a user-specified status update 880. If so the routine gets the user-specified status update and stores the status update on the mobile device in step 885. The user-specified status update may include the status of one or more content-presentation devices and/or content receivers/distributors including whether an individual device is on or busy. The status may also include in some embodiments where the device is located for portable content presentation devices. In addition, the status update may depend on the type of device. For example, status for a DVR may include content scheduled to be record and how much space is left to record programs. The user-specified status update may also include actions performed on other devices (e.g., searches saved in the CM system, previously created groups of devices or pieces of content) and user preferences. After storing the user-specified status update or if the routine determined that the indications were not for getting a user-specified status update, the routine proceeds to step 890.

At step 890, the routine performs other indicated actions as appropriate. Other indicated operations may include browsing preferences, setting access controls, synchronizing preferences and state with the CM system, updating the local/remote functionality based on the current location, receiving content to store on the mobile device, managing playlists, and managing devices. After performing the other indicated actions as appropriate, in step 895, the routine determines whether or not to continue. If so, the routine returns to step 801, and if not, ends at step 899.

Those skilled in the art will also appreciate that in some embodiments the functionality provided by the routines discussed above may be provided in alternative ways, such as being split among more routines or consolidated into fewer routines. Similarly, in some embodiments illustrated routines may provide more or less functionality than is described, such as when other illustrated routines instead lack or include such functionality respectively, or when the amount of functionality that is provided is altered. In addition, while various operations may be illustrated as being performed in a particular manner (e.g., in serial or in parallel) and/or in a particular order, those skilled in the art will appreciate that in other embodiments the operations may be performed in other orders and in other manners. Those skilled in the art will also appreciate that the data structures discussed above may be structured in different manners, such as by having a single data structure split into multiple data structures or by having multiple data structures consolidated into a single data structure. Similarly, in some embodiments illustrated data structures may store more or less information than is described, such as when other illustrated data structures instead lack or include such information respectively, or when the amount or types of information that is stored is altered.

From the foregoing it will be appreciated that, although specific embodiments have been described herein for purposes of illustration, various modifications may be made without deviating from the spirit and scope of the invention. Accordingly, the invention is not limited except as by the appended claims and the elements recited therein. In addition, while certain aspects of the invention are presented below in certain claim forms, the inventors contemplate the various aspects of the invention in any available claim form. For example, while only some aspects of the invention may currently be recited as being embodied in a computer-readable medium, other aspects may likewise be so embodied.

What is claimed is:

1. A method for a personal computer to enable a user to control content presentation on remote content presentation devices through use of a graphical user interface displayed by the personal computer, the method comprising:
displaying to a user of the personal computer a graphical user interface (“GUI”) that includes a view display area to simultaneously display metadata information about multiple digital media content items available for presentation and that includes a content presentation device control area to display information about groups of multiple content presentation devices and to display user-selectable controls for managing presentation of digital media content items via those content presentation devices, the multiple digital media content items being part of a plurality of content items available for presentation that include multiple television programs and multiple other items having content of one or more media types other than video information, the displayed metadata information for the television programs including electronic programming guide information;
receiving one or more indications of a selection by the user of at least one of the digital media content items via the displayed metadata for those content items, and of a selection by the user of at least one of the multiple content presentation devices of one of the groups via the displayed information for those content presentation devices; and
after receiving an indication of an instruction from the user to present the selected at least one digital media content items on the selected at least one content presentation devices, the instruction received via selection by the user of at least one of the displayed user-selectable controls of the content presentation device control area, automatically directing presentation of those digital media content items on those content presentation devices,
so that a user can use the displayed graphical user interface to direct presentation of selected content items to selected content presentation devices from displayed groups of content presentation devices.

2. The method of claim 1 wherein the personal computer is networked with a digital video recorder device that stores at least some of the multiple television programs for later presentation after previously recording those television programs and is networked with a media center device that stores at least some of the multiple other digital media content items for later presentation, wherein the graphical user interface is part of a content management system executing on the personal computer to manage content items available via the media center device and via the digital video recorder device, and wherein the groups of multiple content presentation devices include multiple groups that each include multiple content presentation devices sharing one or more attributes associated with the group, the attributes associated with the groups being based on one or more of indicated locations, indicated types of devices, indicated types of content presentation capabilities, indicated associated users, and an indicated degree of permanence of the devices as being available in a location.

3. A method for a computing device to enable a user to control content presentation on content presentation devices through use of a graphical user interface displayed by the computing device, the method comprising:
receiving metadata information for multiple digital media content items of one or more types that are each available for presentation;
displaying to a user of the computing device a graphical user interface having information about at least some of the multiple digital media content items, the displayed graphical user interface including at least some of the received metadata information for the at least some digital media content items;
providing capabilities to the user via the displayed graphical user interface to identify a group of multiple related content presentation devices that are available to present content and to select at least one of those content presentation devices;
and
after receiving an indication of an instruction from the user to present one or more digital media content items on the selected at least one content presentation devices, automatically directing presentation of the one or more digital media content items on the selected at least one content presentation devices.

4. The method of claim 3 wherein the received instruction from the user includes an indication of at least one digital media content item selected from the displayed metadata information.

5. The method of claim 3 wherein the identified group of multiple related content presentation devices includes devices that are related based at least in part on being associated with an indication location.

6. The method of claim 3 wherein the displayed graphical user interface further display information about multiple groups of content presentation devices of multiple types, and wherein the identified group of multiple related content presentation devices includes devices that are related based at least in part on each being of one of the multiple types.

7. The method of claim 3 wherein the identified group of multiple related content presentation devices includes devices that are related based at least in part on each having a type of content presentation capabilities.

8. The method of claim 3 wherein the identified group of multiple related content presentation devices includes devices that are related based at least in part on each being temporary available to present content under control of the displayed graphical user interface.

9. The method of claim 3 wherein the identified group of multiple related content presentation devices includes devices that are related based at least in part on each having a capability to present content protected by an indicated digital rights management (“DRM”) technology.

10. The method of claim 3 wherein the identified group of multiple related content presentation devices includes devices that are related based at least in part on one or more user-specified criteria.

11. The method of claim 3 wherein the providing of the capabilities to the user via the displayed graphical user interface includes providing capabilities to display information about multiple distinct groups of related content presentation devices.

12. The method of claim 3 further comprising dynamically discovering content presentation devices that become available to present content.

13. The method of claim 3 wherein the displayed graphical user interface includes a content presentation device control area to display information about at least some content presentation devices and to display one or more user-selectable controls for managing presentation of one or more content items via those content presentation devices.

14. The method of claim 3 further comprising providing capabilities to the user via the displayed graphical user interface to identify other devices of one or more types for manipulating content in manners other than presenting the content, and, after receiving an indication of an instruction from the user to manipulate one or more digital media content items via at least one of the other devices, automatically sending one or more instructions to cause the manipulating to be performed.

15. The method of claim 3 further comprising receiving an indication from the user of one or more access controls for the selected at least one content presentation devices, and wherein the automatically directing of the presentation of the one or more digital media content items on the selected at least one content presentation devices occurs in accordance with the indicated access controls.

16. The method of claim 15 wherein the access controls for the selected at least one content presentation devices include an associated parental control for one of the content presentation devices such that use of the one content presentation device is available only to users who supply an access code corresponding to the parental control, and wherein the automatic directing of the presentation of a digital media content item on the one content presentation device in accordance with the parental control includes prompting the user to provide the access code before performing the directing of the presentation of the digital media content item on the one content presentation device.

17. The method of claim 15 wherein the indicated access controls are parental controls, and wherein the method further comprises performing configuration based on the indicated access controls in such a manner as to maintain those access controls at future times.

18. The method of claim 15 wherein the selected at least one content presentation devices of the identified group include all of the content presentation devices of the group, and wherein the indicated access controls are indicated for the identified group such that the access controls are applied to all of the content presentation devices of the group.

19. The method of claim 3 wherein the one or more digital media content items to present include multiple digital media content items that are part of an indicated playlist, the multiple digital media content items including one or more television programs.

20. A computer-readable medium whose contents cause a computing device to enable a user to control content manipulation by remote devices via a graphical user interface displayed by the computing device, by performing a method comprising:
receiving metadata information for multiple pieces of content that are each available for presentation at one or more associated presentation times;
displaying to a user of the computing device a graphical user interface having controls to enable a user to manage manipulation of the multiple content pieces by multiple remote devices, at least one of the remote devices being a content presentation device; and
after receiving an indication of an instruction from the user to manipulate one or more of the content pieces via one or more selected remote devices of the multiple remote devices, automatically directing the manipulation of the one or more content pieces on the selected remote devices.

21. The computer-readable medium of claim 20 wherein the displayed graphical user interface includes at least some of the received metadata information for the multiple pieces of content, wherein at least some of the multiple pieces of content are television programs and at least one of the one or more content pieces is a television program, wherein the one or more selected remote devices include at least one content presentation device available to present television programs, and wherein the directing of the manipulation of the one or more content pieces on the selected remote devices includes causing at least one of the one or more content pieces to be presented on the at least one content presentation devices.

22. The computer-readable medium of claim 20 wherein the displayed graphical user interface includes at least some of the received metadata information for the multiple pieces of content, wherein the remote devices include one or more devices for recording and/or distributing content, wherein the one or more selected remote devices include at least one of the one or more devices for recording and/or distributing content, and wherein the directing of the manipulation of the one or more content pieces on the selected remote devices includes causing at least one of the one or more content pieces to be recorded and/or distributed by the at least one devices.

23. The computer-readable medium of claim 20 wherein the multiple remote devices are each members of one of multiple groups of devices, wherein the graphical user interface displays information about the multiple groups of devices, and wherein selecting of the one or more remote devices by the user is performed in a manner based at least in part on the displayed information for at least one of the multiple groups.

24. The computer-readable medium of claim 20 wherein the computer-readable medium is a memory of the computing device and/or is a data transmission medium transmitting to the computing device a generated data signal containing the contents.

25. The computer-readable medium of claim 20 wherein the contents are instructions that when executed cause the computing device to perform the method.

26. A computing system configured to enable a user to control presentation of content items via a graphical user interface through use of information about groups of content presentation devices, comprising:
a display; and
a content management system configured to present on the display a graphical user interface containing controls to enable a user to control presentation of digital media content items on content presentation devices of multiple groups, at least some of the digital media content items being television programs and at least one of the groups of content presentation devices having one or more content presentation devices able to present television programs, and configured to, after receiving an indication of one or more selections by the user of at least one digital media content item and at least one content presentation device of one of the groups, automatically cause the selected digital media content items to be presented on the selected content presentation devices.

27. The computing system of claim 26 wherein the graphical user interface further includes metadata information for multiple of the digital media content items, wherein selecting of the at least one digital media content items is based on selection of displayed metadata information for those digital media content items, and wherein the at least one selected digital media content items are each a television program.

28. The computing system of claim 27 wherein the causing of the selected digital media content items to be presented on the selected content presentation devices includes sending one or more instructions to at least one other device, the at least one other devices each being at least one of a set-top box, a digital video recorder device and a media center device.

29. The computing system of claim 26 wherein the content management system includes software executing in memory of the computing system.

30. The computing system of claim 26 wherein the content management system consists of a means for presenting on the display a graphical user interface containing controls to enable a user to control presentation of digital media content items on content presentation devices of multiple groups, at least some of the digital media content items being television programs and at least one of the groups of content presentation devices having one or more content presentation devices able to present television programs, and for, after receiving an indication of one or more selections by the user of at least one digital media content item and at least one content presentation device of one of the groups, automatically causing the selected digital media content items to be presented on the selected content presentation devices
